(19) United States
(12) Patent Application Publication
(10) Pub. No.: US 2012/0117128 A1
(43) Pub. Date: May 10, 2012

(54) INFORMATION PROCESSING APPARATUS AND INFORMATION PROCESSING METHOD, AND PROGRAM

(75) Inventors: Toshiya Hamada, Saitama (JP); Kenichiro Aridome, Kanagawa (JP)

(73) Assignee: SONY CORPORATION, Tokyo (JP)

(21) Appl. No.: 13/382,700

(22) PCT Filed: Jun. 30, 2010
(86) PCT No.: PCT/JP2010/061160

§ 371 Date: Jan. 6, 2012

(30) Foreign Application Priority Data
Jul. 15, 2009 (JP) 2009-167301

(51) Int. Cl. G06F 17/30

(52) U.S. Cl. 707/822; 707/E17.01

(57) ABSTRACT

A configuration in which a reproducing process is enabled by constructing a virtual file system without using a local memory is realized. At the time of data reproducing process from a medium having BDMV standard compliant data in the BDMV directory and BDMV standard non-compliant data, for example, the 1080/60p or the 3D image data, are subject to the reproducing process by constructing the virtual file system in which the virtual file name corresponding to the data recorded in the BDAV or BU directory without performing the data transfer to the local memory at the time of data reproducing process from the media having a plurality of directories recorded in the BDAV or BU directories. With this configuration, the recording and reproducing of the BDMV standard compliant data and the BDMV standard non-compliant data can be performed without performing the data transfer to the local memory.

### TECHNICAL FIELD

The present invention relates to an information processing apparatus and an information processing method, and a program. More specifically, the invention relates to an information processing apparatus and an information processing method, and a program which are configured to execute a data recording process or a data reproducing process using recording media such as a disc and a flash memory.

### BACKGROUND ART

For example, recording and reproducing apparatuses such as PCs, video cameras, players, recorders, and the like perform data recording and reproduction using various media such as a hard disk, disk-type media including DVDs, Blu-ray Discs (Registered Trademark) and the like, and flush memories.

When the data recording and reproduction is performed using these media, the data recording and reproducing apparatus performs a data recording and reproducing process according to a format defined in advance by applying a recording and reproducing application compliant with a predetermined standard. For example, examples of application standards for recording and reproducing a high-definition high-vision video include BDMV and BDAV. These application standards are designed as application standards for data recording and reproduction using mainly a BD (Blu-ray Disc (registered trademark)).

Although the BDMV or the BDAV are application standards for the data recording and reproducing using mainly the BD as described above, the recording media is not limited to the BD, and are data recording and reproducing application standards which are applicable to the data recording and reproducing using not only the BD, but also other media such as flush memories as the recording medium.

The BDMV is an application standard developed for BD-ROMs in which, for example, movie contents or the like are recorded in advance and, principally, is widely used as BD-ROMs which do not allow rewriting of packaged contents or the like. The BDMV is characterized in that navigation commands or BD-J as programs for controlling reproduction according to a user's operation are stored in a disc to provide an interactive function intended by a content producer. The BDMV is also characterized in that recording and reproducing using a menu screen including graphics and buttons are enabled.

For reference sake, the BDMV has several versions and, for example, BD-RE 3.0 standard, which is one of standards of the BDMV, is an application standard which is applicable also to recordable BD discs.

In contrast, the BDAV is an application standard developed for the purpose of being used for BD-REs which are rewritable and BD-Rs which allow recording only once.

The BDAV is a standard used very often for recording and reproducing videos shot by users using a video camera or the like.

The BDAV does not have an interactive function or a program for realizing creation of a menu in various designs or a display process like the BDMV and does not have a function such as a button display process. The menu provided by the BDAV standard are simple listed data made up of thumbnail images. If utilization of the menu in various designs or the interactive function provided by the BDMV standard is wanted, a program on the side of the recording and reproducing apparatus is used. In other words, there is no other choice than using, for example, functions integrated on the side of a recorder or a player.

The BDMV standard is a standard designed for the purpose of not hindering reproduction of the packaged contents such as movies recorded in the BD using BD-ROM players which are already diffused widely. In order to ensure reproduction compatibility, specifications are strictly defined by a standards organization being named as BDA (Blu-ray Disc Association).

The BDMV standard also imposes limitations on modes of data of contents to be recorded in media such as a disc and the like. More specifically, for example, data which can be recorded as HD (High Definition) images is defined to be only data of predetermined formats such as 1080/60i and 1080/50i. The expression [1080/60i] indicates that HD (High Definition) images having 1920×1080 pixels are recorded and reproduced on the basis of 1080 lines as 60 field images per second using an interlace system. The symbol [i] denotes the interlace system. In this connection, a progressive system is denoted by [p].

The present high-vision data is defined as an image of 1920×1080 pixels. However, apparatuses which are capable of recording and reproducing images of approximately 4000×2000 pixels (=4K×2K) as higher-definition images are developed. In addition, various apparatuses such as [1080/60p] which performs recording and reproducing in the progressive system, which is different from the interlace system described above, or apparatuses which perform recording and reproducing for right eye images and left eye images for 3D images, which are three-dimensional images, have been developed. In particular, the video cameras developed in recent years are capable of recording 1080/60p images described above, 3D images, or 4K×2K images, and are considered to be used widely in the future.

However, as described above, the current BDMV standard does not allow the 4K×2K images or 1080/60p, and 3D image data as recording and reproducing data. Therefore, there is a problem in that even when the super high-definition images of 4k×2k are generated as the recording data, data recording conforming the existing BDMV standard cannot be performed.

In contrast, the BDAV standard allows recording of AV data in various formats on the precondition of being used in recorders. Therefore, there is no constraint of reproduction compatibility except that part of the AV data formats must be absolutely reproducible. Therefore, the BDAV has flexibility in expansion of standards in comparison with the BDMV. In other words, the 4K×2K images or 1080/60p, and 3D image data can be set as the recording and reproducing data. However, there is a problem in that the interactive function and the menu screen made up of graphics and buttons cannot be used as described above.

It is also possible to use an apparatus which is capable of executing both of the recording and reproducing process compliant with the BDAV application standard, and the recording and reproducing process compliant with the BDMV application standard. However, in this case, for example, utilization of the user friendly menu having titles and designs created by using the BDMV function is enabled as regards the data set in the BDMV directory. However, the menu described above cannot be used when reproducing the image set in the BDAV directory, and there is no choice but to use a simple listed data including thumbnail images created by the BDAV function. That is, there is a problem that, even in the apparatus capable of processing both data of the BDMV and the BDAV, a menu integrating the BDMV directory and data access such as reproduction instruction of data set in the BDAV directory cannot be used.

As described in Patent Document 1 (JP-A-2007-179671), there is also a technology of recording data for constructing a virtual file system (for example, captions) in an optical disc, copying the same to a local storage, constructing the virtual file system for reproduction. However, although copying to local is possible when the data has a small capacity as the captions, if data having a large capacity such as 4K×2K images, 1080/60p, or 3D image data is copied to the local storage, copying takes long time and, moreover, the capacity of the local storage is consumed.

### CITATION LIST

### Patent Literature

Patent Document 1: JP-A-2007-179671

### SUMMARY OF INVENTION

### Technical Problem

In view of such circumstances as described above, it is an object of the present invention to provide an information processing apparatus and an information processing method, and a program configured to record data which is not permitted by BDMV such as 4K×2K images, 1080/60p, or 3D image data, and configured to be capable of using BDMV specific functions such as a menu having various designs and an interactive function which are permitted by a BDMV standard.

### Means for Solving the Problems

A first aspect of the present invention is an information processing apparatus including: a data processing unit configured to perform a data reproducing process from a recording medium, wherein

the data processing unit has a configuration of constructing a virtual file system in which a virtual file name is set for part of data recorded in the recording medium, and

executing the data reproducing process in which the constructed virtual file system is applied, and

the data processing unit

creates a first file name conversion table including the virtual file name set in the virtual file system and a file name indicating a data recording destination in the recording medium in one-to-one correspondence for the data for which the virtual file name is set,

thereby constructing the virtual file system without performing data transfer in the recording medium.

In addition, in an embodiment of the information processing apparatus of the present invention, the data processing unit has a configuration of

constructing the virtual file system including data set in a first directory for recording data compliant with a first application standard set in the recording medium and data set in a directory other than the first directory set in one virtual directory and

executing the data reproducing process in which the constructed virtual file system is applied, and

the data processing unit

creates the first file name conversion table including a file name set in the virtual file system and the file name indicating the data recording destination in the recording medium in one-to-one correspondence for the data set in directories other than the first directory, and

constructs the virtual file system without transferring data set in the directory other than the first directory.

In addition, in an embodiment of the information processing apparatus of the present invention, wherein the data processing unit

acquires a file name of data-to-be-copied included in a data copy command, which is a process command for storing the data set in the directory other than the first directory in a local memory and creating the first file name conversion table.

In addition, in an embodiment of the information processing apparatus of the present invention, the data copy command is a data copy command issued by executing a program recorded in the recording medium.

In addition, in an embodiment of the information processing apparatus of the present invention, the data processing unit

creates a second file name conversion table created on the assumption of being used in the virtual file system constructed by storing data set in the directory other than

the first directory in the local memory and the first file name conversion table by using the file name of the data-to-be-copied included in the data copy command.

In addition, in an embodiment of the information processing apparatus of the present invention, wherein the data processing unit

sets management information on all data-to-be-reproduced set in the first directory and the directory other than the first directory in the virtual directory set in the virtual file system as the management information used as index information on the data-to-be-reproduced and performs data reproducing process using the management information.

In addition, in an embodiment of the information processing apparatus of the present invention, the data processing unit

the management information is management information including any one of an index file, a movie object file, a playlist file, or a clip information file to be applied to the reproducing process on the basis of the virtual file system.

In addition, in an embodiment of the information processing apparatus of the present invention, the first application standard is a BDMV standard, and the first directory is a BDMV directory, and

the data processing unit constructs the virtual file system having a virtual BDMV directory which is set to record:

the first directory includes

data-to-be-reproduced recorded in the BDMV directory,

data-to-be-reproduced recorded in a BDAV directory which is different from the BDMV directory, and

the management information recorded in a third directory other than the BDMV and BDAV directories as data-to-be-recorded.

In addition, in an embodiment of the information processing apparatus of the present invention, the first application standard is the BDMV standard and the first directory is the BDMV directory, and

the data processing unit constructs the virtual file system having the virtual BDMV directory which is set to record:

the first directory includes

the data-to-be-reproduced recorded in the BDMV directory,

data-to-be-reproduced and the management information recorded in a second directory different from the BDMV directory as the data-to-be-recorded.

In addition, a second aspect of the present invention is an information processing method for executing data reproduction from a recording medium in an information processing apparatus including:

a virtual file system constructing step for constructing a virtual file system in which a virtual file name is set for part of data recorded in the recording medium by a data processing unit; and

a data reproducing step for executing a data reproducing process in which the virtual file system is applied by the data processing unit, wherein

the virtual file system constructing step is a step of creating a first file name conversion table including the virtual file name set in the virtual file system and a file name indicating a data recording destination in the recording medium in one-to-one correspondence for data having the virtual file name set thereto, and

constructing the virtual file system without performing data transfer in the recording medium.

Furthermore, a third aspect of the present invention is a program that causes an information processing apparatus to execute data reproduction from a recording medium including:

a virtual file system constructing step for causing a data processing unit to construct a virtual file system in which a virtual file name is set for part of data recorded in the recording medium; and

a data reproducing step for causing the data processing unit to execute a data reproducing process in which the virtual file system is applied,

wherein the virtual file system constructing step is a step of causing to create a first file name conversion table including the virtual file name set in the virtual file system and a filename indicating a data recording destination in the recording medium in one-to-one correspondence for data having the virtual file name set thereto, and

causing to construct the virtual file system without performing data transfer in the recording medium.

The program according to the present invention is a program provided, for example, for an information processing apparatus or a computer system which is capable of executing various program code, for example, by a storage medium. By executing such a program by a program executing unit on the information processing apparatus or the computer system, a process according to the program is realized.

Other objects, characteristics, or advantages of the present invention will be apparent by a detailed description on the basis of example of the present invention or appended drawings described later. In this specification, the term “system” means a configuration of a logical set of a plurality of apparatuses, and is not limited to those having a plurality of apparatuses of various configurations in an identical housing.

### Advantageous Effects of Invention

According to an example of the present invention, at the time of data reproducing process from a medium having a plurality of recorded directories including BDMV standard compliant data in the BDMV directory, and BDMV standard non-compliant data, for example, the 1080/60p or the 3D image data, in the BDAV or BU directory, the reproducing process is performed by constructing the virtual file system in which the virtual file name for the recorded data in the BDAV or BU directory is set without performing data transfer to the local memory. With this configuration, the recording and reproducing of the BDMV standard compliant data and the BDMV standard non-compliant data can be performed without performing the data transfer to the local memory.

### BRIEF DESCRIPTION OF DRAWINGS

FIG. 1 is a drawing showing a directory configuration as a file management structure of a medium (information recording medium) compliant with a BDMV standard.

FIG. 2 is a drawing showing a directory configuration as a file management structure of a medium (information recording medium) compliant with a BDAV standard.

FIG. 3 is an explanatory drawing showing an example of difference between the BDMV standard and the BDAV standard.

FIG. 4 is an explanatory drawing showing a virtual file system (VFS).

FIG. 5 is an explanatory drawing showing an example of a filename conversion table (manifest file (BUMF)).

FIG. 6 is an explanatory drawing showing an outline of data recording and reproducing process according to a first example of the present invention.

FIG. 7 is an explanatory drawing showing the virtual file system (VFS) which is constructed and used in the information processing apparatus of the present invention.

FIG. 8 is an explanatory drawing showing a directory configuration (disc package) showing a data recording configuration in the medium.

FIG. 9 is an explanatory drawing showing a directory configuration (virtual package) showing a data configuration of the virtual file system.

FIG. 10 is an explanatory drawing showing an example of the file name conversion table to be applied to a reproducing process in which the virtual file system is used.

FIG. 11 is an explanatory drawing showing a binding unit data area (BUDA).

FIG. 12 is a drawing showing a flowchart for explaining a sequence of a data reproducing process according to the first example of the present invention.

FIG. 13 is an explanatory drawing showing an outline of data recording and reproducing process according to a second example of the present invention.

FIG. 14 is an explanatory drawing showing the directory configuration (disc package) showing the data recording configuration in the medium.

FIG. 15 is an explanatory drawing showing the directory configuration (virtual package) showing the data configuration of the virtual file system.

FIG. 16 is an explanatory drawing showing a configuration of the information processing apparatus according to an example of the present invention.

### DESCRIPTION OF EMBODIMENTS

Referring now to the drawings, an information processing apparatus, an information recording medium and an information processing method, and a program will be described in detail. The description will be given on the basis of the following items.

### 1. Outline of BDMV Standard and BDAV Standard

2. Reproducing process using Virtual File System (VFS) of the related art
3. Reproducing process using Virtual File System (VFS) according to an example of the present invention
4. Example of Process in which BDVA directory is not set (Example 2)

### 5. Example of Configuration of Information Processing Apparatus

[1. Outline of BDMV Standard and BDAV Standard]

First of all, an outline of existing BDMV standard and BDAV standard will be described. As described above, the BDMV standard and the BDAV standard are designed as application standards for data recording and reproduction using mainly a BD (Blu-ray Disc (Registered Trademark)), but is an application standard which can be applied to the data recording and reproduction using other media such as a flash memory without limiting the recording media to the BD.

The BDMV is an application standard developed for BD-ROMs in which, for example, movie contents or the like are recorded in advance.

The BDAV is an application standard developed for the purpose of being used for BD-REs which are rewritable and BD-Rs which allow recording only once.

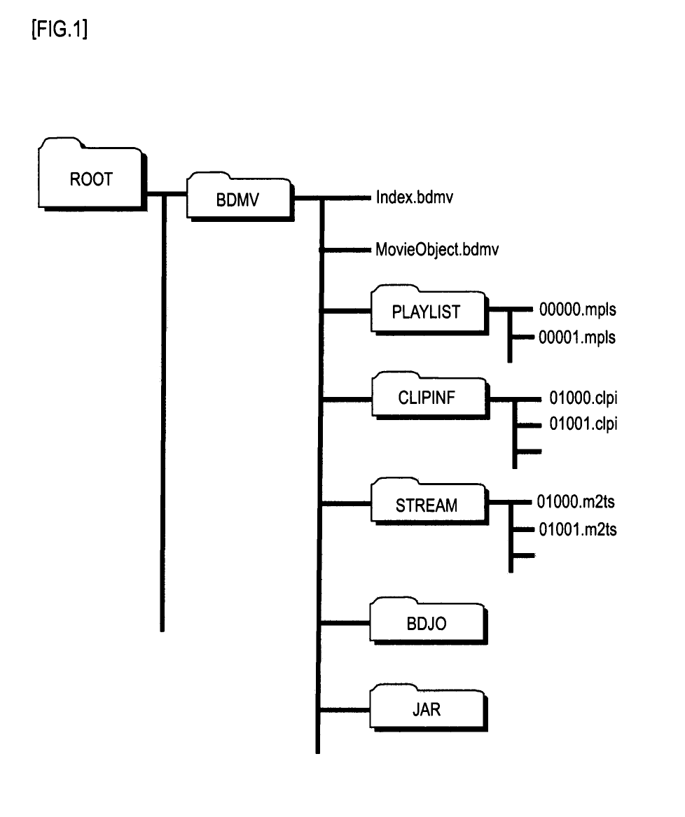

A BDMV directory as a data recording configuration recorded in the media compliant with the BDMV standard is shown in FIG. 1. The BDMV standard described below complies with BD-RE 3.0 standard, which is one of standards of the BDMV which permits the data recording process to be performed.

As shown in FIG. 1, in the BDMV standard, when recording data in the media, for example, the moving image stream is coded into MPEG2-TS stream for recording. As shown in FIG. 1, the BDMV directory is placed under a root [Root] directory as directory [BDMV].

Immediately below the directory [BDMV],

an index file [index.bdmv], and

a movie object file [MovieObject.bdmv] are recorded.

In addition, as descendent directories of the BDMV directory [BDMV],

a playlist directory [PLSYLIST],

a clip information directory [CLIPINF],

a stream directory [STREAM],

a BDJO directory [BDJO], and

a JAR directory [JAR]

are set.

Playlist files [xxxxx.mpls] are set in the playlist directory [PLAYLIST], clip information files [xxxxx.clpi] are set in the clip information directory [CLIPINF], and clip AV stream files [xxxxx.m2ts] are set in the stream directory [STREAM].

The index file, the movie object file, and the playlist file are management information files applied to reproduction of data stored in the clip AV stream file. These management information files are referred to as data base files, or data base. Detailed description of the respective files will be given below.

The index file [index.bdmv] is a management information file for the recording data of the entire media. For example, indices (information on the relation of correspondence between titles and movie objects) are recorded for the respective titles set as units of the recording data. When the medium (information recording medium) is loaded on a recording and reproducing apparatus, the index file is read first, so that a user can view the titles described in the index file and specify the reproduction thereof.

The movie object file [MovieObject.bdmv] is a file in which the management information on the playlists is stored. A plurality of programs for executing a reproducing process using the various playlists are included. A program to be applied to an AV stream reproducing process and, for example, a program to be applied to a menu display process are also included.

The playlist files [xxxxx.mpls] recorded in the playlist directory [PLAYLIST] are provided corresponding to the titles displayed to the user, and are reproduction lists each including at least one play item. Each play item is a reproduction segment specifying information having a reproduction start point (IN-point) and a reproduction end point (OUT-point) for the clip. By arranging a plurality of the play items in the playlist, on a time axis, the order of reproduction of the respective reproduction segments can be specified.

The clip information files [xxxxx.clpi] recorded in the clip information directory [CLIPINF] are set corresponding to the AV stream files [xxxxx.m2ts] recorded in the stream directory [STREAM]. The clip information files are files in which information on a stream required when reproducing the actual stream is written.

The AV stream files [xxxxx.m2ts] recorded in the stream directory [STREAM] are files in which the streams recorded in MPEG2-TS format are stored. The image data is stored in these files.

In the BDJO directory [BDJO] and the JAR directory [JAR], for example, various data processing programs, functions, and so on applied with Java (registered trademark) are stored. For example, a program for setting the virtual file system used in the data reproducing process, a program to be applied to menu creating and menu displaying processes, and a program for realizing an interactive function at the time of data recording and reproduction are included.

For reference sake, in the BDMV directory, for example, directories for recording back up data and AACS related data files such as copyright management information are set in addition to the directories and files shown in FIG. 1.

For reference sake, in the following description, the files in which the data-to-be-reproduced are stored such as the AV stream file are collectively referred to as “stream files” for brevity. Also, the index file, the movie object file, the playlist file, and the clip information file are collectively referred to as management information or data base.

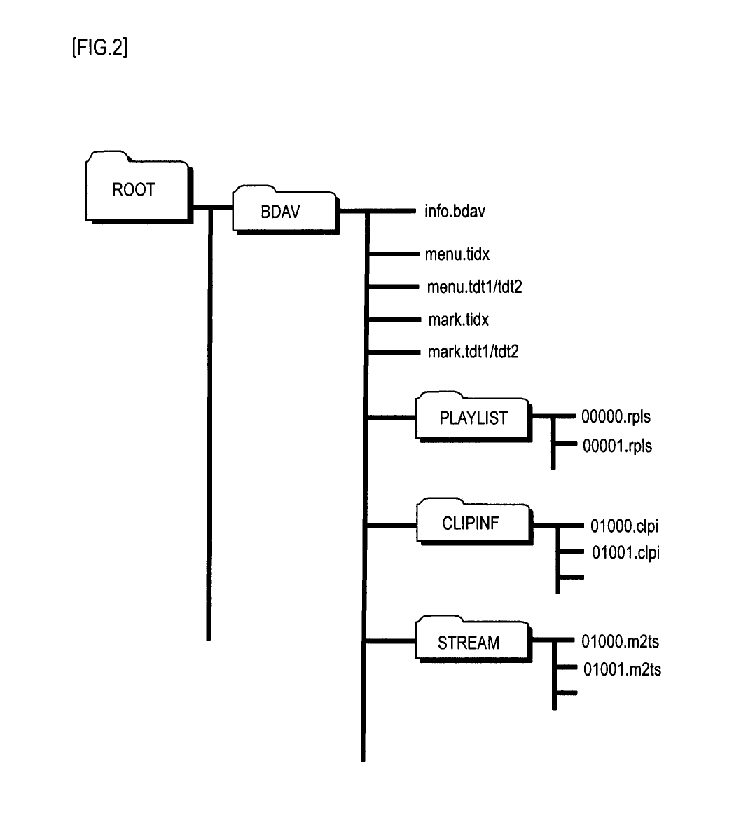

Referring now to FIG. 2, the BDAV directory as a data recording configuration recorded in the media compliant with the BDAV standard will be described. The BDAV standard described below complies with BD-RE2.1 standard, which is one of standards of the BDAV. As shown in FIG. 2, the BDAV directory is placed under the root [Root] directory.

Immediately below the directory [BDAV],

an info file [info.bdav],

menu files [menu.tidx], [menu.tdt1/tdt2], and

mark files [mark.tidx], [mark.tdt1/tdt2]

are recorded.

In addition, as descendent directories of the BDAV directory [BDAV],

the playlist directory [PLSYLIST]

the clip information directory [CLIPINF], and

the stream directory [STREAM]

are set.

The playlist files [xxxxx.mpls] are set in the playlist directory [PLAYLIST], the clip information files [xxxxx.clpi] are set in the clip information directory [CLIPINF], and the AV stream files [xxxxx.m2ts] are set in the stream directory [STREAM].

The info file [info.bdav] is a file in which the management information on the entire BDAV directory is stored.

In the menu files [menu.tidx], [menu.tdt1/tdt2], thumbnail images of representative images of the respective AV stream files are stored. The [menu.tidx] stores thumbnail management information, and the [menu.tdt1/tdt2] stores thumbnail images.

Unlike the BDMV standard, the BDAV standard does not provide a function to create a menu having various information, and is set to provide a simple menu display which displays leading images of videos shot by the user in the form of thumbnails. The menu files [menu.tidx], [menu.tdt1/tdt2] manage and store the thumbnail images therefor.

The mark files [mark.tidx], [mark.tdt1/tdt2] are files in which the thumbnail images corresponding to marked positions which are index information set in an editing process on the images shot by the user (AV stream file) are managed and stored. The [mark.tidx] stores the thumbnail management information and [mark.tdt1/tdt2] stores thumbnail images.

The playlist directory [PLAYLIST], the clip information directory [CLIPINF], and the stream directory [STREAM] are set in substantially similar to the BDMV directory described with reference to FIG. 1 above.

The playlist files [xxxxx.rpls] are recorded in the playlist directory [PLAYLIST].

The clip information files are recorded in the clip information directory [CLIPINF], and the AV stream files [xxxxx.m2ts] recorded in MPEG2-TS format for example, are recorded in the stream directory [STREAM].

As described thus far with reference to FIG. 1 and FIG. 2, the BDMV directory and the BDAV directory have similar configuration, but the BDMV application standard and the BDAV application standard are different in data format which permits recording and reproducing. Also, there is a significant difference in menu creating functions and interactive functions.

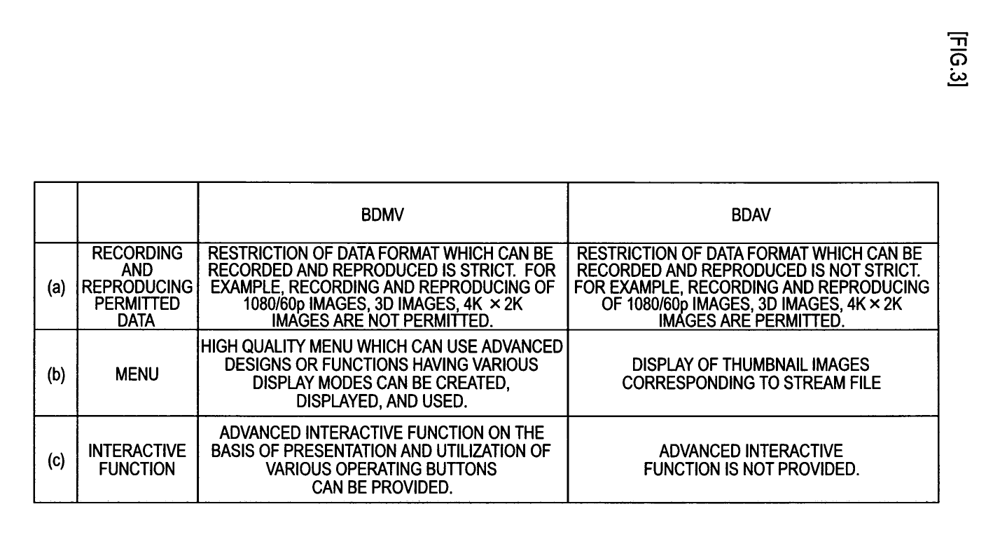

The difference between the BDMV application standard and the BDAV application standard will be described with reference to a table shown in FIG. 3.

(a) Recording and Reproducing Permitted Data

The BDMV application standard is strict in restriction on the data formats which can be recorded and reproduced. For example, in the case of the BDMV application standard, recording and reproduction of the [1080/60p image], which is a HD (High Definition) image having 1920×1080 pixels in a progressive system or 3D images as three-dimensional images, or 4K×2K images having approximately 4000×2000 pixels are not permitted.

Examples of the image data formats which are permitted as the recording and reproducing data in the BDMV application standard includes, for example, [1080/60i].

The [1080/60i] indicates that HD (High Definition) images having 1920×1080 pixels are recorded and reproduced on the basis of 1080 lines as 60 field images per second using an interlace system.

In contrast, the BDAV application standard is not strict in restriction on the data formats which can be recorded and reproduced. For example, recording and reproducing of 1080/60p images, 3D images, and 4K×2K images are permitted.

(b) Menu Display Function

According to the BDMV application standard, a high-performance menu which allows, for example, free title setting and has various designs can be created and used by using a program included in the movie object file [MovieObject.bdmv] or Java (registered trademark) stored in BDJO and JAR directories described above with reference to FIG. 1.

The menu screen provided in the BDAV application standard is only the display of the thumbnail images using [menu.tidx], [menu.tdt1/tdt2] described above with reference to FIG. 2.

(c) Interactive Function

According to the BDMV application standard, display and usage of buttons for various operations are possible using the Java (registered trademark) programs stored in the BDJO, JAR directories described above with reference to FIG. 1, and an advanced interactive function can be provided.

In the BDAV application standard, only stop of reproduction of the content can be executed, and the advanced interactive function cannot be provided.

In the following description, the apparatuses executing the recording and reproducing process compliant with the BDMV application standard are referred to as a BDMV player, or a BDMV recorder, or a BDMV (recording and reproducing) apparatus. Also, the apparatuses executing the recording and reproducing process compliant with the BDAV application standard are referred to as a BDAV player, or a BDAV recorder, or a BDAV (recording and reproducing) apparatus.

The BDMV apparatus sets the BDMV directory shown in FIG. 1 as a medium (recording medium) to execute the data recording and reproducing process, and the BDAV apparatus sets the BDAV directory shown in FIG. 2 as a medium (recording medium) to execute the data recording and reproduction.

However, many of the apparatuses which perform the recording and reproducing process compliant with the BDAV application standard are capable of executing a reproducing process function compliant with the BDMV application standard.

These apparatuses are capable of performing processes using the BDAV application for the recording and reproducing process using the recordable media such as BD-REs or BD-Rs, and using the BDMV application when reproducing the BD-ROMs in which the movie or the like is already recorded.

Therefore, the BDAV player, or the BDAV recorder, or the BDAV (recording and reproducing) apparatus will be described as apparatus which are capable of executing both of the recording and reproducing process compliant with the BDAV application standard and the recording and reproducing process compliant with the BDMV application standard.

The BDMV application standard and the BDAV application standard are standards designed by the BDA (Blu-ray Disc Association) as described above. For example, materials are disclosed in [http://www.blu-raydisc.com/].

As described with reference to FIG. 3, when the BDMV apparatus which executes the recording and reproducing process compliant with the BDMV standard is used, recording of 1080/60p images, 3D images, and 4K×2K images cannot be achieved. For example, even when the 1080/60p images, the 3D images, the 4K×2K images and the like are shot with a video camera compliant with the BDMV standard, these images cannot be recorded. If the BDAV standard is complied with, recording is possible. However, there is a problem in that the high-performance menu or the interactive function cannot be used.

As described above, it is possible to use the apparatus which can execute both of the recording and reproducing process compliant with the BDAV application standard and the recording and reproducing process compliant with the BDMV application standard. However, even when the apparatus described above is used, although utilization of the high-performance menu according to the BDMV function is possible for the data set in the BDMV directory, this menu cannot be used for reproducing the data set in the BDAV directly and hence there is no choice but using the thumbnails created by the BDAV function.

In other words, even with the apparatus which is capable of processing both of the BDMV data and the BDAV data, there is a problem in that data access such as a data reproduction command set in the BDMV directory and the BDAV directory cannot be performed using consolidated menu.

A configuration which solves these problems will be described below. In other words, it is a configuration which allows recording and reproducing of the BDMV standard non-compliant data such as 1080/60p images, 3D images, 4K×2K images and the like which are not permitted to be recorded and reproduced in the BDMV standard and, simultaneously, allows access to both of the BDMV standard compliant data and the BDMV standard non-compliant data from one menu.

In the configuration according to the present invention described below, both of the BDMV standard compliant data and the BDMV standard non-compliant data can be accessed and reproduced in the BDMV apparatus of the related art from one menu without causing any problem in reproduction compatibility.

[2 Reproducing Process using Virtual File System (VFS)]

In the information processing apparatus of the present invention, data which is not permitted to be recorded and reproduced in the BDMV standard is recorded in a directory other than the BDMV directory, and a virtual file system (VFS) is constructed at the time of reproduction, and the reproduction is achieved by using the BDVM reproducing mechanism.

Before describing a detailed example of a process according to the present invention, general mode of usage of the virtual file system (VFS) used in the reproducing process in the present invention will be described.

The virtual file system (VFS) is originally invented for performing the reproducing process by consolidating two different recording media, for example, a disc such as a BD and data stored in the local memory such as a hard disk. In other words, the reproducing process is performed by constructing one imaginary virtual file system (VFS) including data recorded respectively in two memory media and using the virtual file system (VFS) by a reproducing application. For reference sake, methods of construction and usage of the virtual file system are disclosed in JP-A-2007-257047, which is a former patent application by the applicant of the present invention.

Examples of detailed modes of usage of the virtual file system include a following mode of usage, for example. Foreign film (main content) is recorded in a disc such as a BD or a DVD, and Japanese caption data (sub content) is downloaded from a server and is stored in a hard disk (local memory).

The virtual file system (VFS) is used for a process of reproducing two contents as described above, that is, film recorded in the disc, which is the main content, and caption data recorded in the local memory, which is the sub content, simultaneously.

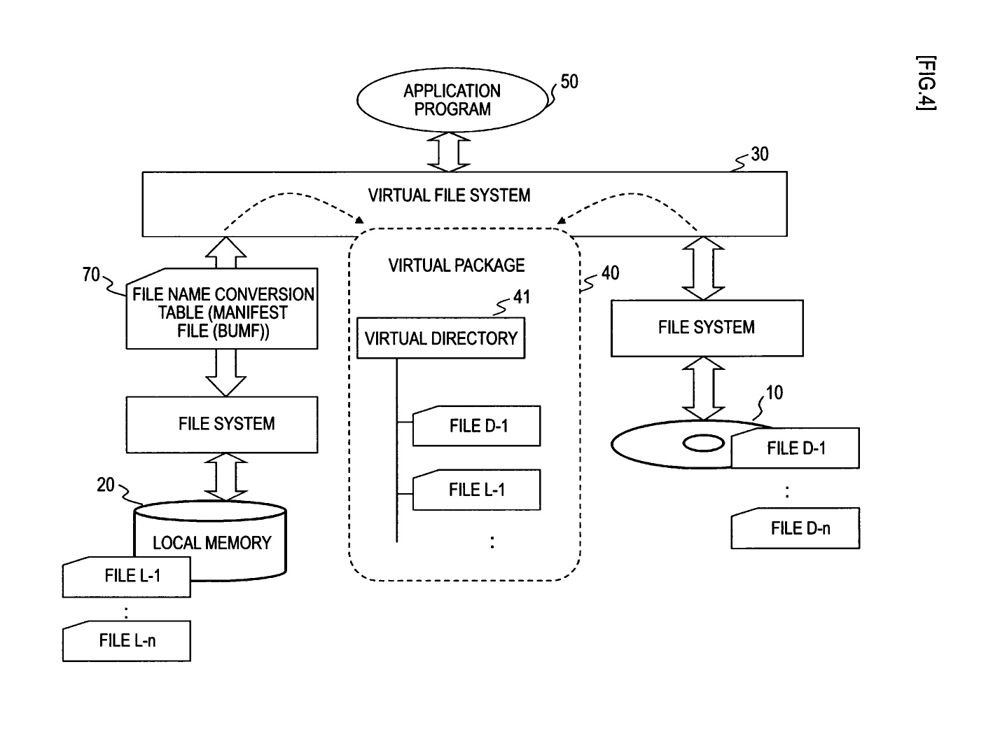

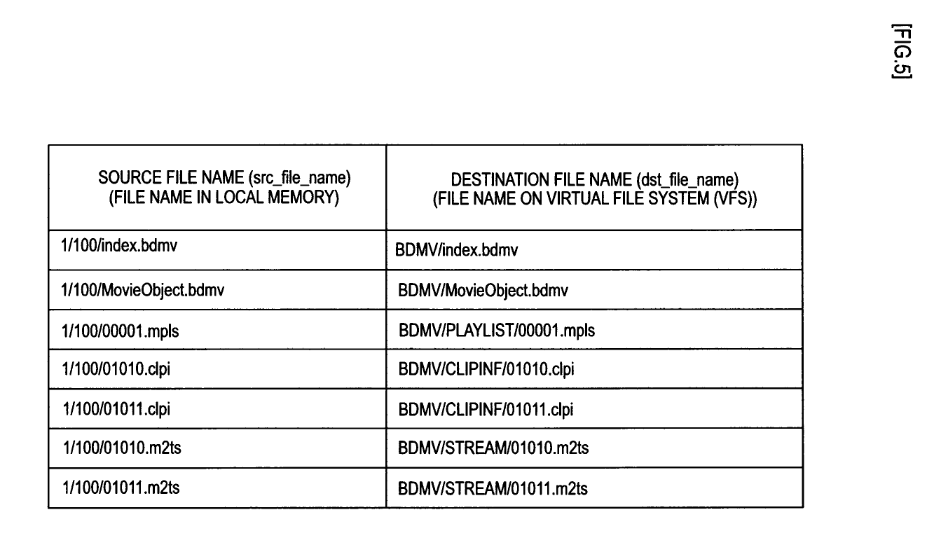

Referring now to FIG. 4 and FIG. 5, a construction process and an example of usage of a general virtual file system (VFS) will be described. FIG. 4 is an explanatory drawing showing creation of a virtual file system (VFS) 30 by consolidating contents stored in a medium 10 such as a BD or a DVD and data stored in a local memory 20 such as the hard disk, and the reproducing process.

An application program 50 shown in FIG. 4 is a reproducing application. The application program 50 operates files recorded in the medium 10 or files recorded in the local memory 20 via the virtual file system (VFS) 30.

The virtual file system 30 performs a role of shielding the difference of recording media (file systems) from the application program 50. The application program 50 is capable of operating the files recorded in the respective recording media by using the same API without regard to the difference of the recording media in which the files are recorded.

The virtual file system (VFS) 30 is created when the medium 10 is loaded on the apparatus, or by a merge of the file system of the medium 10 and the file system in the local memory 20 at the time of execution of the application program, and the created virtual file system (VFS) 30 is stored in the memory of a reproducing apparatus executing the application program 50. For reference sake, the virtual file system (VFS) is renewed every time when the directories or the files recorded in the local memory 20 are changed by writing of files.

The application program 50 performs data access using a virtual directory 41 of a virtual package 40 of the virtual file system (VFS) 30. The application program 50 performs a reproducing process by accessing data on the assumption that all of recorded data in the medium 10 and the recorded data in the local memory 20 are set in the virtual directory 41 of the virtual package 40.

The application program 50 is capable of executing an access to data file set in the virtual directory 41 by interpreting the virtual directory 41 of the virtual package 40 to be an actual directory set in the medium 10.

A file name to be set in the virtual directory 41 is used as pass information for the data access. The file name to be set in the virtual directory 41 in the case of the data recorded in the actual directory in the medium 10 is the file name thereof. In contrast, in the case of respective data recorded in the local memory 20, virtual file names assumed to be recorded in the actual directory in the medium 10 are set. By setting in this manner, the application program 50 is allowed to access all the data by interpreting that these data are recorded in the medium 10.

When performing the data access on the basis of the virtual directory 41, access to the data recorded in the actual directory in the medium 10 is achieved by using the file names set in the virtual directory 41 without change. It is because the file name (pass) set in the virtual directory 41 is the same as the file name in the actual directory in the medium 10.

However, as regards the data recorded in the local memory 20, even when an attempt is made to access using a virtual file name set in the virtual directory, the actual data stored in the local memory 20 cannot be acquired.

In order to solve this problem, a file name conversion table (manifest file (BUMF)) 70 is used. The file name conversion table 70 is a table having data including destination file names (dst_file_name) as the virtual file names in the virtual directory 41 and source file names (src_file_name) indicating actual recording destinations of the data, that is, recording destinations (passes) in the local memory 20 in one-to-one correspondence.

The file name conversion table 70 is referred to as a manifest file (BUMF). This file name conversion table (manifest file (BUMF)) 70 is recorded in the local memory 20. When recording the sub content such as the caption in the local memory, the information processing apparatus performs a process of setting an entry corresponding to the corresponding data-to-be-recorded to the file name conversion table (manifest file (BUMF)) 70.

An example of configuration of the file name conversion table (manifest file (BUMF)) is shown in FIG. 5. As shown in FIG. 5, the file name conversion table (manifest file (BUMF)) is set as data including the source filenames (src_file_name) indicating the recording destinations (passes) in the local memory 20 and the destination file names (dst_file_name) as the virtual filenames in the virtual directory 41 in one-to-one correspondence.

The destination filename (dst_file_name) is a filename in the virtual directory 41. The application program 50 shown in FIG. 4 accesses a file on the basis of the destination file names (dst_file_name). When the destination file name (dst_file_name) is registered in the file name conversion table (manifest file (BUMF)) shown in FIG. 5, the source file name (src_file_name) corresponding to the destination file name (dst_file_name) is acquired and data is acquired from the local memory 20 on the basis of the source file name (src_file_name).

With the process as described above, the application program 50 is capable of performing the reproducing process by accessing the data recorded in the two different media of the medium 10 and the local memory 20 in the same manner as the data recorded in a single medium.

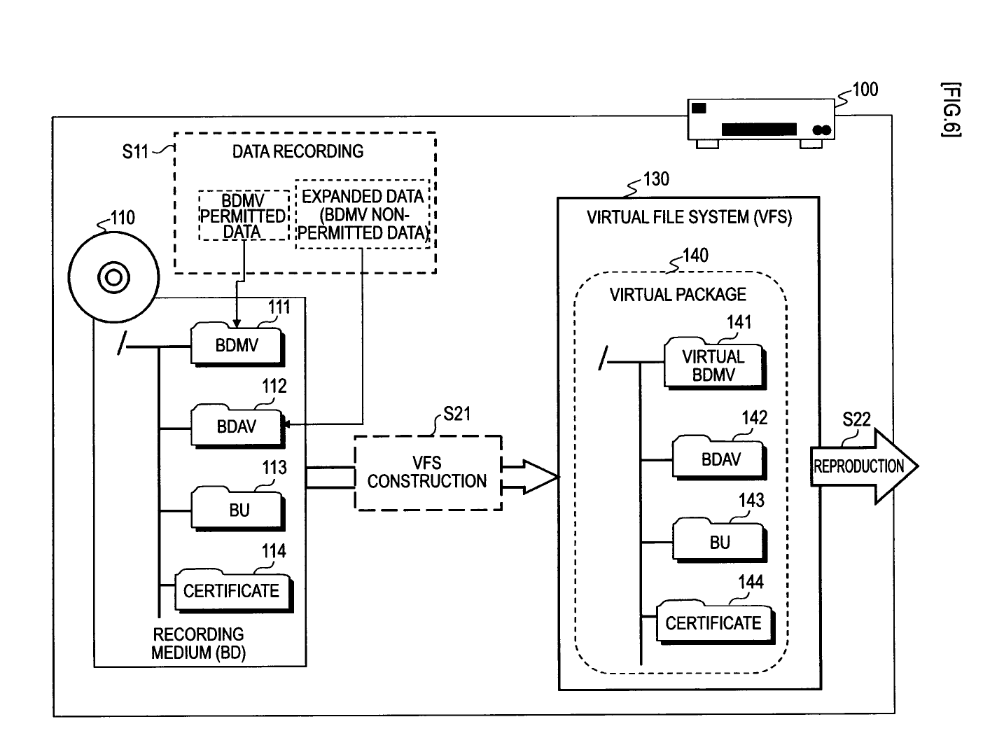

Referring now to FIG. 6 onward, the reproducing process using the virtual file system (VFS) in the information processing apparatus of the present invention will be described. In the reproducing process using the virtual file system (VFS) according to the present invention, the local memory is not used.

Using a recording media including both of the BDMV directory and the BDAV directory provided therein, the virtual file system having a single virtual directory in which the data set in the respective directories are consolidated is constructed and is applied to the reproducing process. The local memory is not used in the constructing process of the virtual file system.

Referring now to FIG. 6, an outline of the data recording and reproducing process by the information processing apparatus according to Example 1 in the present invention will be described. An information processing apparatus 100 shown in FIG. 6, having a medium (information recording medium) 110 loaded thereon, executes the data recording and reproducing process. In this example, the medium 110 is, for example, a data recordable BD (Blu-ray Disc (registered trademark)). For reference sake, the medium 110 is not limited to the BD, but may be other media such as a flash memory.

First of all, a data recording process for the medium 110 by the information processing apparatus 100 will be described. The medium 110 is assumed to be a data recordable medium, for example, a BD-RE, or a BD-R. When performing only the reproducing process, a medium which is not rewritable, for example, a BD-ROM, may be used.

The information processing apparatus 100 sets following directories;

a BDMV directory 111,

a BDAV directory 112,

a BU directory 113, and

a certificate (CERTIFICATE) 114.

in the medium 110 as shown in Fig. i. these directories are set. This process is executed by a program held by the information processing apparatus in the memory of the apparatus.

The BDMV directory 111 is a directory having a similar configuration to that described above with reference to FIG. 1, and

the BDAV directory 112 is a directory having a similar configuration to that described above with reference to FIG. 2.

The BU directory 113 is a binding unit directory, and is a directory for the recording management information required when constructing a virtual file system (VFS).

The certificate (CERTIFICATE) directory 114 is a directory for recording information to be applied to the construction of the virtual file system (VFS) and the creation of the file name conversion table.

A process to be performed when the information processing apparatus 100 executes data recording on the medium 110 is shown in Step S11.

As shown in Step S11, when the data-to-be-recorded is a BDMV standard compliant data, the recording process is performed in the BDMV directory 111. Also, when recording data having formats other than the BDMV standard, for example, the BDMV standard non-compliant data such as 1080/60p images, 3D images, and 4K×2K images as described above, a process of recording in the BDAV directory 112 is executed. In the following description, the BDMV standard non-compliant data such as 1080/60p images, 3D images, and 4K×2K images is referred to as expanded data. For reference sake, even when the data is the BDMV standard compliant data, it can be recorded in the BDAV directory.

For the reference sake, at the time of data recording process, creation or renewal and recording process are performed not only on the AV stream file, but also on the clip information file and the playlist file. In addition, a renewal process on the database files such as the movie object file and the index file on an as-needed basis is performed.

When the data recording process is executed, the management information on the BU directory 113 is renewed. This process is a management information renewal process required when constructing the virtual file system (VFS) described later. More specifically, index files [index.bdmv], and movie object files [MovieObject.bdmv] corresponding to all AV stream files recorded in the BDMV directory 111, the BDAV directory 112 are renewed according to the data record and are recorded in the BU directory 113. In other words, the management information to be recorded in the BU directory 113 includes management information on all the data-to-be-reproduced recorded in the medium.

In this manner, the information processing apparatus 100 executes the process of recording basically in the BDMV directory 111 for the BDMV standard compliant data, and executes the process of recording in the BDAV directory 112 for the expanded data (BDMV standard non-compliant data).

Subsequently, an outline of the data reproducing process will be described. The information processing apparatus 100 of the present invention is capable of specifying both of the data recorded in the BDMV directory and the data set in the BDAV directory from one menu for the reproducing process. This menu is a menu created by the BDMV standard.

The information processing apparatus 100 according to the present invention is capable of reproducing both of the data recorded in the BDMV directory and the data set in the BDAV directory using an interactive function which is available in the BDMV standard.

The menu display or the interactive function are functions provided by the movie object file [MovieObject.bdmv], the BDJO directory [BDJO], or, for example, Java (registered trademark) recorded in the JAR directory [JAR] in the BDMV directory described above with reference to FIG. 1.

In the related art, these programs could not be used for the data recorded in the BDAV directory. However, by using the virtual file system (VFS) set in the configuration of the present invention, the BDMV standard compliant menu function or the interactive function can be used also for the data recorded in the BDAV directory.

At the time of reproducing process, as shown in Step S21 shown in FIG. 6, a process of constructing the virtual file system (VFS) 130 on the basis of the data recorded in the medium 110 is performed. Subsequently, in Step S22, the reproducing process using the virtual file system (VFS) 130 is executed.

The virtual file system (VFS) 130 is a virtual file system used by the reproducing application program executed by the information processing apparatus 100, and includes a virtual package 140 having a directory configuration shown in the drawing. The information processing apparatus 100 constructs the virtual package 140 having a directory configuration shown in the drawing in the memory of the information processing apparatus, and performs data access.

In the configuration of the present invention, the virtual file system (VFS) 130 is not constructed for using the memory data in the local memory together with the data stored in the medium, but is constructed for accessing all the data stored in the medium 110.

As shown in FIG. 6, the package 140 set in the virtual file system (VFS) 130 includes,

a virtual BDMV directory 141,

a BDAV directory 142,

a BU directory 143, and

a CERTIFICATE directory 144.

In the virtual BDMV directory 141, in addition to the files set in the BDMV directory 111, which is an actual directory in the medium 110, files set in other actual directories, that is, in the BDAV directory 112 or the BU directory 113 are set as virtual files. Specific file configuration will be described in detail later.

The reproducing application of the information processing apparatus which performs the reproducing process applied with the virtual file system accesses the virtual BDMV directory 141 and acquires the AV stream file as the data-to-be-reproduced.

In the virtual BDMV directory 141, both of the BDMV directory 111, which is an actual directory in the medium 110, and the AV stream file set in the BDAV directory 112 are set. Furthermore, in the virtual BDMV directory 141, the management information file set in the BU directory 114, which is an actual directory in the medium 110 is also set.

The file set in the BDMV directory 111 is set in the virtual BDMV directory 141 with the file name thereof without being changed. In contrast, the data in the BDMV directory 111 and the BU directory 113 are set in the virtual BDMV directory 141 with virtual file names. The data set with the virtual file names are subject to a process of acquiring actual destinations of data stored (pass information) by using the file name conversion table. Detailed description about these processes will be given later.

The reproducing application of the information processing apparatus 100 is capable of accessing and reproducing all the data-to-be-reproduced (data set in the BDMV and BDAV directories) stored in the medium 110 by accessing the virtual BDMV directory 141 without accessing the BDAV directory 142 of the virtual file system (VFS) 130.

In other words, not only the BDMV standard compliant data recorded in the BDMV directory 111, BDMV standard non-compliant data such as 1080/60p images, 3D images, 4k×2K images as the expanded data (BDMV standard non-compliant data) recorded in the BDAV directory 112 can also be reproduced by using the virtual BDMV directory 141 of the virtual file system (VFS) 130.

Also, in the virtual BDMV directory 141, the management information file recorded in the BU directory 113, which is the actual directory in the medium 110, for example, the index file [index.bdmv], and the movie object file [MovieObject.bdmv] are set.

The reproducing application of the information processing apparatus 100 executes the reproducing process by applying the management information such as the index file [index.bdmv], and the movie object file [MovieObject.bdmv] set in the virtual BDMV directory 141. Specific reproduction sequence will be described in detail later.

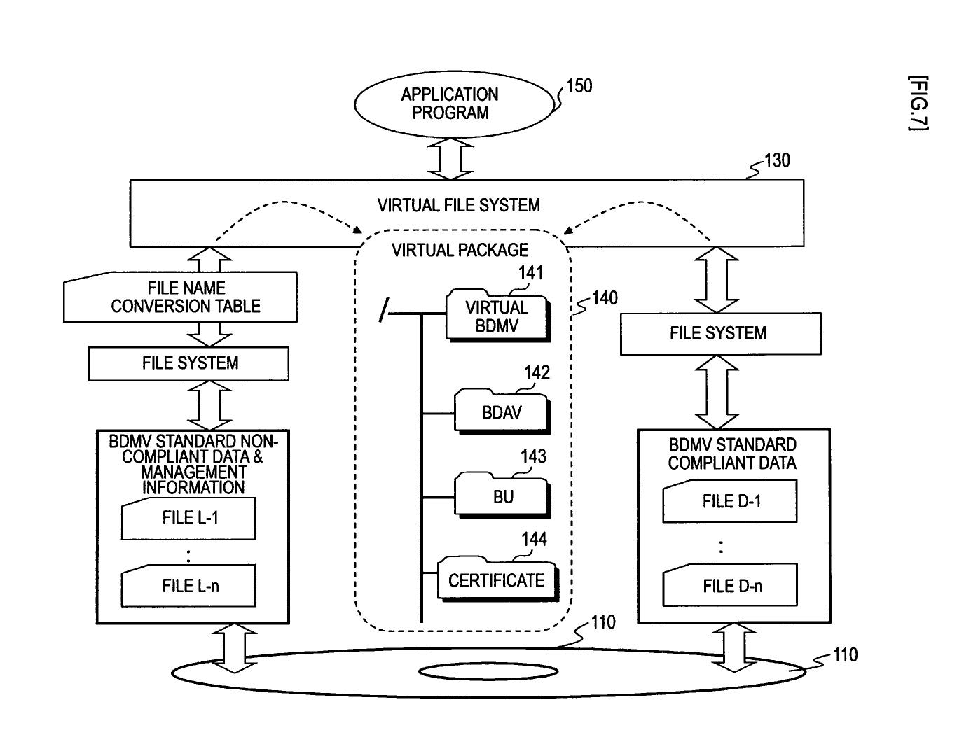

Referring now to FIG. 7, an example of configuration of the virtual file system (VFS) according to the present invention will be described. FIG. 7 is an explanatory drawing showing creation of the virtual file system (VFS) 130 in which data stored in directories having different contents stored therein in the medium 110 such as the BD is consolidated and the reproducing process.

An application program 150 shown in FIG. 7 is a reproducing application executed by the information processing apparatus 100 shown in FIG. 6. The application program 150 operates files in the different directories recorded in the medium 110 via the virtual file system (VFS) 130.

The virtual file system 130 performs a role of shielding the difference of directories from the application program 150. The application program 150 is capable of operating the files recorded in the medium 110 without regard to the difference of directories in which the files are recorded.

The virtual file system (VFS) 130 is constructed by loading the medium 110 in the apparatus and being triggered by execution of a program (Java (registered trademark) program, for example) recorded in the medium 110. A specific construction sequence will be described in detail with reference to a flowchart later. The constructed virtual file system (VFS) 130 includes a virtual package shown in the drawing, which is stored in the memory in the reproducing apparatus which executes the application program 150.

The application program 150 performs data access using a virtual directory of the virtual package 140 of the virtual file system (VFS) 130. As described above, not only the BDMV directory in the medium 110, but also the AV stream file as the data-to-be-reproduced set in the BDAV directory is set in the virtual BDMV directory 141.

As described above, in the BDMV directory in the medium 110, the BDMV standard compliant data can be recorded, but the expanded data (BDMV standard non-compliant data) such as 1080/60p images, 3D images, and 4K×2K images cannot be recorded. These expanded data (BDMV standard non-compliant data) is recorded in the BDAV directory.

However, in the virtual BDMV directory 141 used in the virtual file system (VFS) 130, not only the BDMV standard compliant data, but also the expanded data (BDMV standard non-compliant data) such as 1080/60p images, 3D images, and 4K×2K images are set.

The management information corresponding to the BDMV standard compliant data and the expanded data (BDMV standard non-compliant data) are also set in the virtual BDMV directory 141. Therefore, the application program 150 is capable of performing the reproducing process on the BDMV standard compliant data and the expanded data (BDMV standard non-compliant data) by using the information set in the virtual BDMV directory 141.

In this example, the data storing process with respect to the local memory is not necessary, and the reproducing process using the virtual file system (VFS) is enabled with the apparatus that does not have the local memory. Also, the process of copying the data stored in the medium in the local memory is not necessary, so that the construction of the virtual file system (VFS) and starting of data reproduction using the virtual file system (VFS) in a short time are enabled.

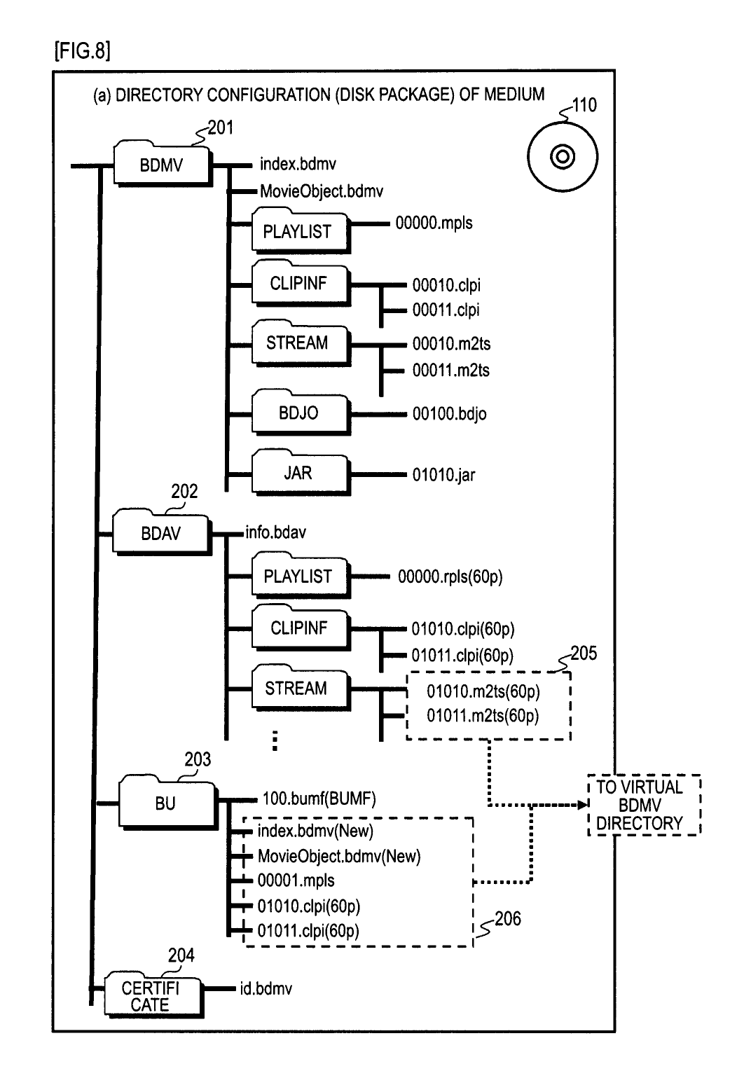

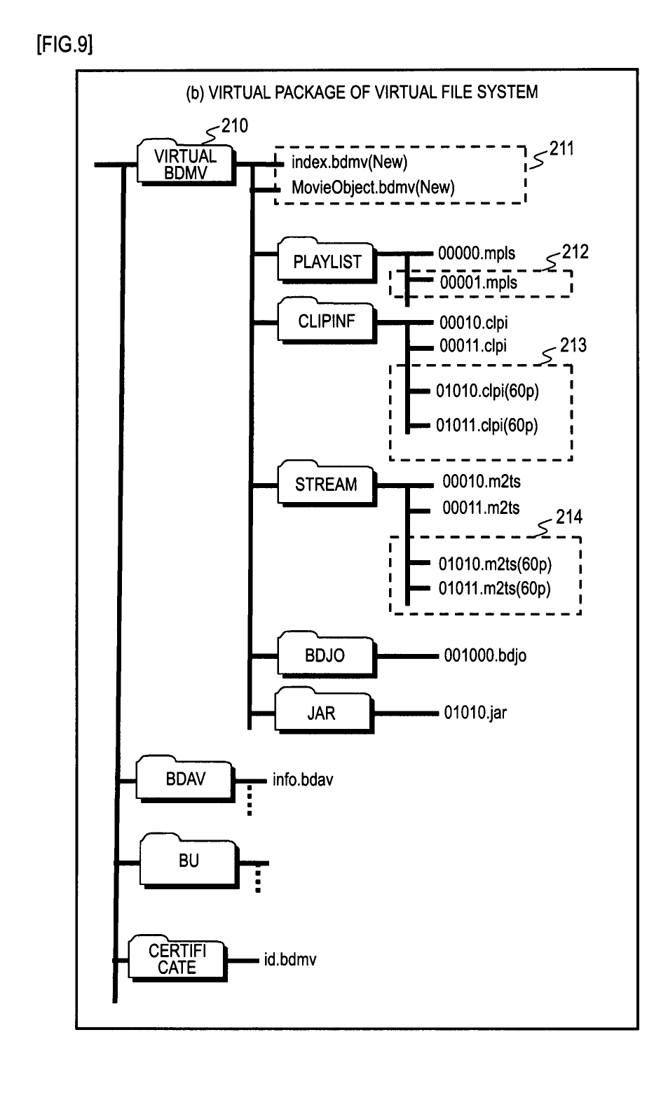

Referring now to FIG. 8 to FIG. 9, an actual directory configuration in the medium 110 and a detailed example of the directory configuration in the virtual file system 130 will be described.

In FIG. 8 to FIG. 9, examples of data configuration (a) Directory Configuration (disc package) of Medium [FIG. 8] (b) Virtual package of Virtual File System (VFS) [FIG. 9] are shown.

(a) The directory configuration (disc package) of the medium shown in FIG. 8 includes;

a BDMV directory 201,

a BDAV directory 202,

a BU directory 203, and

a certificate (CERTIFICATE) directory 204,

as described above.

In the BDMV directory 201, data compliant with the BDMV standard and the management information of the corresponding data is recorded.

In the BDAV directory 202, expanded data which is not compliant with the BDMV standard and the management information is recorded.

In the BU directory 203, the management information file used when constructing the virtual file system (VFS) and the file name conversion table (manifest file (BUMF)) similar to that described above with reference to FIG. 5 are recorded.

In the certificate (CERTIFICATE) directory 204, the information to be applied to the construction of the virtual file system (VFS) and the creation of the file name conversion table are stored.

As shown in FIG. 8, a stream file 205 recorded in the BDAV directory 202 and data 206 recorded in the BU directory 203 are data set in the virtual BDMV directory of the virtual file system (VFS).

Referring now to FIG. 9, data set in the virtual BDMV will be described. FIG. 9 shows the virtual package of the virtual file system (VFS). The reproducing application of the information processing apparatus performs the reproducing process using the virtual directory in the virtual file system.

As a directory in the virtual file system, a virtual BDMV directory 210 is set as shown in FIG. 9. Data to be set in the virtual BDMV directory 210 will be described.

The files shown in FIG. 9 as the management information file 211;

an index file [index.bdmv (New)], and

a movie object file [MovieObject.bdmv (New)]

are originally part of the data 206 recorded in the BU directory 203 in the medium 110 shown in FIG. 8.

Although the index file [index.bdmv], and a movie object file [MovieObject.bdmv] are set also in the BDMV directory in (a) the directory configuration (disc package) of the medium, when the reproducing process using the virtual file system is performed,

an index file [index.bdmv (New)], and

a movie object file [MovieObject.bdmv (New)]

in the virtual BDMV directory 210 are used.

These are the data 205 recorded in the BU directory 203 in the actual directory shown in FIG. 8.

The index file [index.bdmv], and the movie object file [MovieObject.bdmv] set in the BDMV directory in (a) the directory configuration (disc package) of the medium shown in FIG. 8 include only the management information set in the BDMV directory in the medium.

However, the index file [index.bdmv], and the movie object file [MovieObject.bdmv] recorded in the BU directory 203 shown in FIG. 8 are data including not only the recorded data in the BDMV directory 201 of the media, but also the management information on the expanded data recorded in the BDAV directory 202. In other words, it is set as data including the management information on all the data-to-be-reproduced recorded in the medium 110.

In the reproducing process using the virtual file system, the reproducing process is performed not only on the data recorded in the BDMV directory 201 in the medium, but also on the expanded data recorded in the BDAV directory 202, the index file [index.bdmv], and the movie object file [MovieObject.bdmv] in the data 206 recorded in the BU directory 203 are set as the management information file 211 in the virtual BDMV directory 210 shown in FIG. 9.

In addition, the following files shown in (b) the virtual package of the virtual file system (VFS) shown in FIG. 9, that is;

the playlist file [00001.mpls] 212

the clip information file [01010.clpi] (60p) 213, and

the clip information file [01011.clpi] (60p) 213,

correspond to the data 206 recorded in the BU directory 203 of the disc package shown in FIG. 8.

Also, these files;

the AV stream file [01010.m2ts] (60p) 214, and

the AV stream file [01011.m2ts] (60p) 214,

correspond to the stream file 205 in the BDAV directory 202 of the disc package shown in FIG. 8.

The (60p) indicates that the data is the [1080/60p] image data of the progressive system, for example. In other words, it indicates that the data is the expanded data (BDMV standard non-compliant data). As described above, 3D images, 4K×2K images and the like are also the BDMV standard non-compliant data, and these data are processed in the same manner.

The files 211 to 214 shown in (b) the virtual package of the virtual file system (VFS) in FIG. 9 have file names set in the virtual file system (VFS) as virtual file names, which are different from the filenames indicating actual recording destinations of the files.

These files are acquired from the medium 110 by using the file name conversion table (manifest file (BUMF)) described above with reference to FIG. 5 and a table created by the information processing apparatus 100 which executes the reproducing process at the time of construction process of the virtual file system (VFS). The file name conversion table (manifest file (BUMF)) is included in the data 206 recorded in the BU directory 203 shown in FIG. 8.

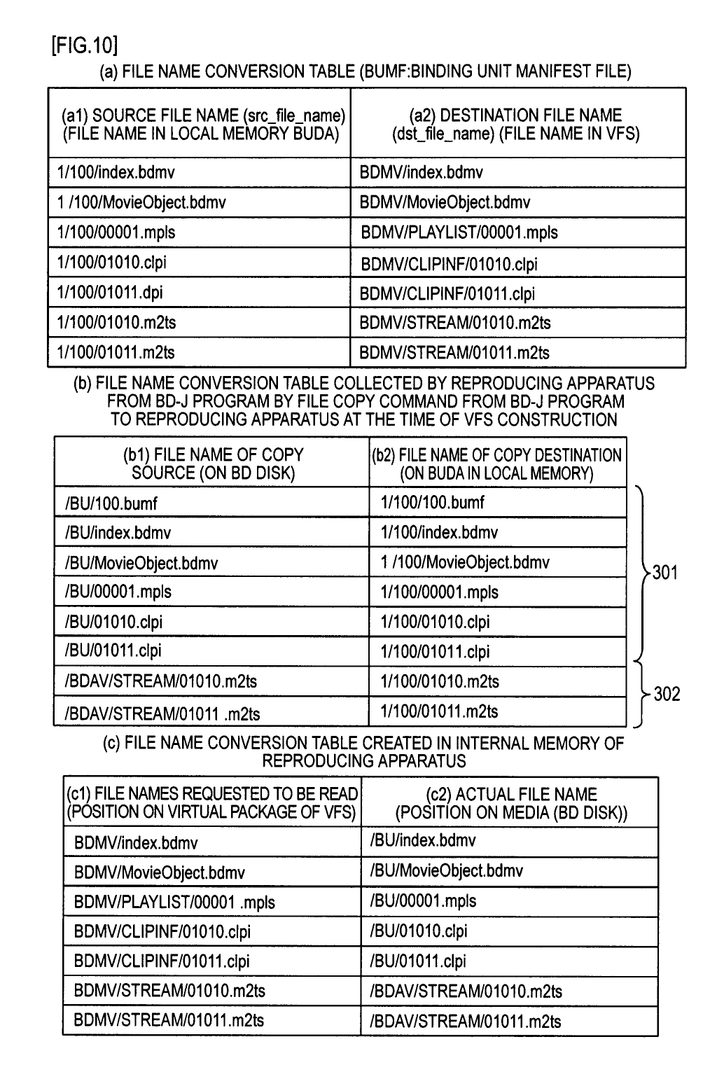

Referring now to FIG. 10, the file name conversion table created by the information processing apparatus 100 at the time of process of constructing the virtual file system (VFS) will be described.

In FIG. 10, three tables (a) to (c);

(a) File Name Conversion Table (BUMF: Binding Unit Manifest File)

(b) File Name Conversion Table collected by Reproducing Apparatus from BD-J Program on the basis of file copy command from BD-J program to Reproducing apparatus at the time of VFS Construction.

(c) File Name Conversion Table created in Internal Memory of Reproducing Apparatus are shown.

(a) The file name conversion table (BUMF: Binding Unit Manifest File) is a file name conversion table (BUMF) similar to that described above with reference to FIG. 5. (a) The file name conversion table (BUMF) is a table set in the BDAV directory or the BU directory, and includes file name conversion information on files to be set in the virtual BDMV directory in the virtual file system (VFS) recorded therein. (a) The file name conversion table (BUMF) is renewed one after another at the time of recording of data in the medium and recorded in the BU directory.

As shown in FIG. 10(a), (a) the file name conversion table (BUMF) is set as data including (a1) source file names (src_file_name) indicating the recording destinations (passes) when the local memory (BUDA) is assumed to be the recording destination and (a2) destination file names (dst_file_name) as the virtual file names in the virtual directory in one-to-one correspondence.

(a2) The destination file name (dst_file_name) is file name on the virtual directory. (a1) The source file name (src_file_name) is set as pass information indicating the relative position of storage in the BU and following directories.

(a1) The source file name (src_file_name) indicating the recording destination (pass) when the local memory (BUDA) is assumed to be a recording destination indicates information on relative position from a binding unit data area (BUDA), which is a data storage area set in the local memory.

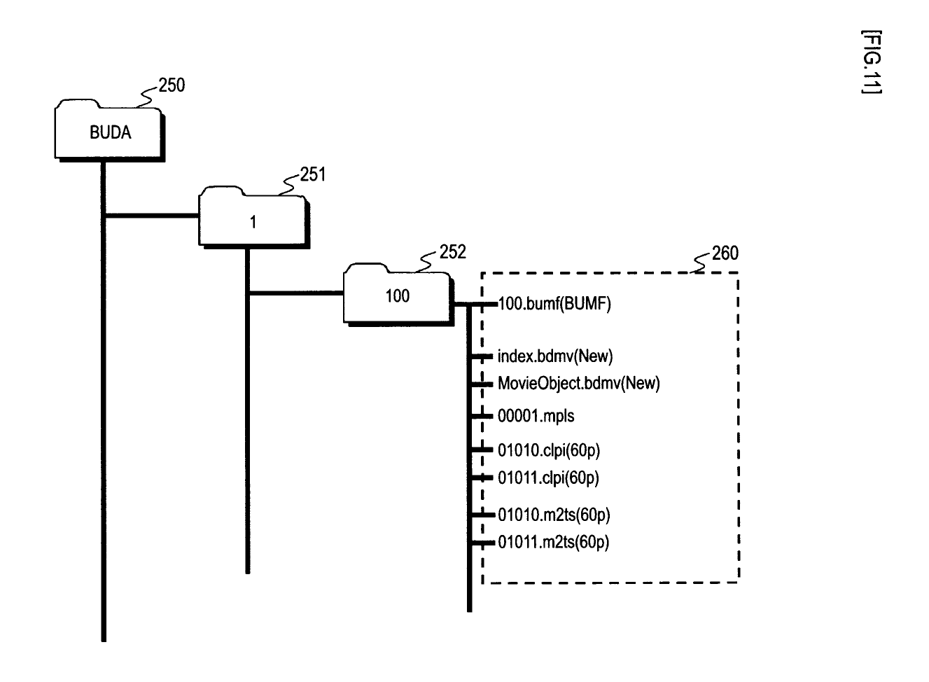

An example of configuration of a BUDA root directory in a case where the local memory (BUDA) is assumed to be a recording destination will be shown in FIG. 11. A descendent directory of a BUDA directory 250 is an Organization directory 251, which is an organization-specific directory such as a studio which has created the contents, and a disc directory 252 as a directory set by a disc-to-disc basis is set therein on a further descendent position thereof.

Data 260 including management information files used at the time of construction of the virtual file system (VFS) is set on a descendent position thereof.

For example, Organization_ID which indicates an organization which has manufactured a disc such as a BD is assumed to be [a], and Disc_ID which is a number specifying the disc is assumed to be [b]. When the reproducing process using the virtual file system in the disc specified by [a] and [b], the binding unit data (Binding Unit Data) indicating data-to-be-stored in the local memory is set under /a/b/ in the BUDA.

In the process of the present invention, although the reproducing process is performed by constructing the virtual file system (VFS) while omitting data storage in the local memory as described above, data-to-be-stored in the medium is created on the assumption that the virtual file system (VFS) is constructed by performing the data storage in the local memory for performing the reproducing process. Therefore, the file name conversion table (BUMF: Binding Unit Manifest File) recorded in the BU directory 203 shown in FIG. 8 at the time of data recording process is also a file name conversion table on the assumption of the process using the local memory.

Therefore, a renewing process such as addition of an entry of the file name conversion table (BUMF: Binding Unit Manifest file) used at the time of data recording process is performed on the assumption of a data arrangement configuration in the local memory as shown in FIG. 11.

Information on [Organication_ID] and [Disc_ID] are stored in a [id.bdmv] file in the certificate (CERTIFICATE) directory 204 shown in FIG. 8. An example of the BUDA directory shown in FIG. 11 is a case on the conditions of Organization_ID=1, and Disc_ID=100.

The binding unit data area (BUDA) is an area which is assumed to be set in a local memory as an area for storing the sub contents in a case of constructing the virtual file system (VFS) by storing the sub contents in the local memory described above with reference to FIG. 4 and consolidating the same with the main contents recorded in the medium (disc) for performing the reproducing process.

The data-to-be-recorded 260 formed of management information files or the like shown in FIG. 11 are created by an organization-by-organization basis such as the studio which has created the contents or by a disc-to-disc bases, and are recorded in the BUDA directory 250. The file name conversion table (manifest file (BUMF)) is set as a configuration which allows recognition of these directory configurations as shown in FIG. 10(a).

The file name conversion table (BUMF) shown in FIG. 10(a) is a BUMF having a similar configuration as that described above with reference to FIG. 5 and having been used in the related art, and is renewed sequentially according to the data recording process on the medium. The file name conversion table (BUMF) shown in FIG. 10(a) is a file name conversion table created on the assumption that the sub contents are recorded in the local memory.

Since the information processing measure of the present invention is set so as not to record the data in the local memory, the file name conversion table (BUMF) shown in FIG. 10(a) cannot be used directly. Therefore, tables shown in FIGS. 10(b), (c) are used.

“(b) File Name Conversion Table collected by Reproducing Apparatus from BD-J Program on the basis of file copy command from BD-J program to Reproducing apparatus at the time of VFS Construction” in FIG. 10(b) will be described.

This table is created by the information processing apparatus 100 which executes the data reproducing process by constructing the virtual file system (VFS) without using the local memory. The information processing apparatus 100 receives a file copy command issued from a program stored in the medium 110, for example, from a Java (registered trademark) program (BD-J) stored in the BDJO/JAR directories, and creates the table in FIG. 10(b) from data included in this file copy command.

The BD-J program issues a file copy command to be set in the virtual BDMV directory at the time of constructing the virtual file system. The BD-J program issues a copy command for constructing the virtual file system on the assumption that the local memory described above with reference to FIG. 4 is used.

In other words, the BD-J program issues a command for causing part of the data stored in the medium, for example, the data 206 including the AV stream file 205 set in the BDAV directory 202 described with reference to FIG. 8 and the management information file set in the BU directory 203 to be copied in the local memory.

However, the information processing apparatus of the present invention creates the file name conversion table shown in FIG. 10(b) using the information on the file name included in the copy command without performing the data copying process to the local memory.

The copy command issued by the BD-J program includes a file name of copy source data-to-be-copied (pass information on the medium) and a file name of copy destination (pass information when assuming the copy destination is the local memory). This data corresponds to the table data shown in FIG. 10(b). In other words,

(b1) File Names of Copy Source (pass information on the media)

(b2) File Names of Copy Destination (pass information on the assumption that the copy destination is the local memory) shown in FIG. 10(b) are correspondence information on these file names.

The BD-J provides the information processing apparatus which executes the reproducing process with this correspondence information.

Data 301 shown in FIG. 10(b) are entries corresponding to the data 206 from the BU directory 203 and following directories in the directory configuration (disc package) of the medium shown in FIG. 8. Also, data 302 shown in FIG. 10(b) includes entries corresponding to the stream files 205 from the BDAV directory 202 and following directories shown in FIG. 8.

(b2) The file name of the copy destination (pass information on the assumption that the copy destination is the local memory) is information identical to (a1) the source file name (src_file_name) in the file name conversion table (BUMF) shown in FIG. 10(a), and is set as pass information indicating the relative position of storage in the BU and following directories.

The information processing apparatus creates the file name conversion table shown in FIG. 10(c) on the basis of the tables (a), (b), and stores the same in the memory of the information processing apparatus.

“(c) File Name Conversion Table created in an Internal Memory of Reproducing Apparatus” shown in FIG. 10(c) includes data having the following file names in one-to-one correspondence.

(c1) File Names requested to be read (File Names on Virtual Package of VFS)

(c2) Actual File Names (indicating the pass on the medium (recorded position))

The filenames in (c1) correspond to (a2) the destination file names (dst_file_name) in the BUMF in FIG. 10(a).

The file names in (c2) correspond to (b1) the file names of the copy source (pass information on the media) in a table shown in FIG. 10(b).

The information processing apparatus analyzes the correspondence relationship between (a2) and (b2) from the relationship (a1). (b2) in the file names in the respective tables shown in FIGS. 10(s), (b), creates the file name conversion table shown in FIG. 10(c), and records the same in the memory.

The information processing apparatus 100 constructs the virtual file system (VFS) without performing the data recording in the local memory, and accesses the files (data 211 to 214 shown in FIG. 9) set in the virtual BDMV directory in the virtual file system by using the file name conversion table shown in FIG. 10(c).

At the time of data access by using the virtual file system (VFS), (c2) the actual file name (indicating the pass on the medium (recorded position)) is acquired from the file names in (c1) shown in FIG. 10(c), that is, from the file names on the virtual package of VFS), and data is acquired from the medium by using (c2) the actual file name.

As shown in FIG. 9, the BDJO, JAE directories are included in the virtual BDMV directory 210 in the virtual file system. Therefore, at the time of reproducing process using the virtual file system, Java (registered trademark) program stored in the BDJO, JAR directories can be used. By using the Java (registered trademark) program, a menu display having various designs is achieved. Also by using the Java (registered trademark) program stored in the BDJO, JAR directories, for example, various control buttons can be displayed for achieving the reproducing process using the interactive function.

In the example shown in the actual directory (disc package) of the medium described above with reference to FIG. 8, the data 206 in the BU directory 203 is assumed to include a playlist file, a clip information file corresponding to the AV stream file recorded in the BDAV directory. These files are recorded also in the BDAV directory 202.

In this example, at the time of constructing the virtual file system (VFS), the AV stream file is selected from the BDAV directory 202 in the medium 110, and other data is selected from the BU directory 203, which are set in the virtual BDMV directory 210 in the virtual file system (VFS) shown in FIG. 9. Therefore, in the actual directory (disc package) configuration of the medium shown in FIG. 8, the playlist file, the clip information file corresponding to the stream file recorded in the BDAV directory 202 are also recorded in the BU directory 203.

However, a configuration of selecting the playlist file, the clip information file corresponding to the stream file recorded in the BDAV directory 202 and setting the same in the virtual BDMV directory 210 in the virtual file system (VFS) shown in FIG. 9 is also possible. In this setting, it is not necessary to record these files in the BU directory 203.

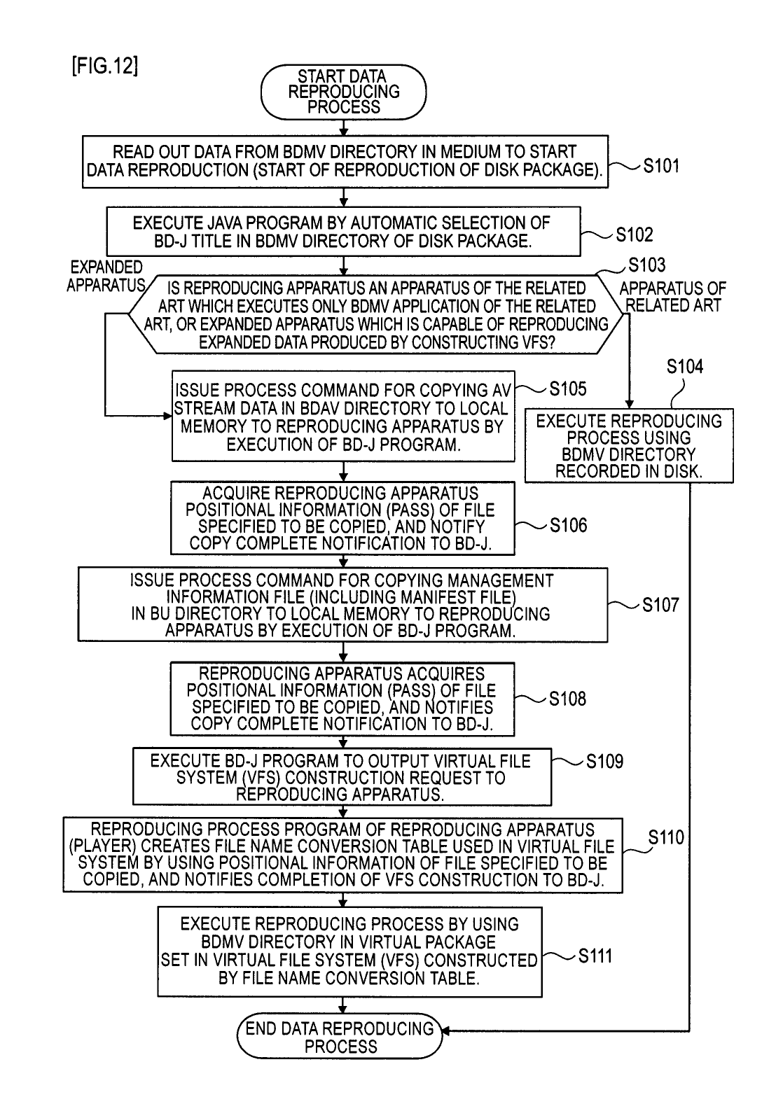

Referring to a flowchart shown in FIG. 12, the data reproducing process sequence in this example will be described. The data reproducing process is executed by the data processing unit in the information processing apparatus. The data processing unit includes a CPU having an application program executing function. The processes in the respective steps of the flowchart shown in FIG. 12 will be described.

In Step S101, the data is read out from the BDMV directory in the recording medium such as a BD, and the data reproduction is started (start of reproduction of the disc package).

In Step S102, the Java (registered trademark) program is executed by automatic selection of the BD-J title in the BDMV directory of the disc package. This process is a process to be executed automatically, for example, according to the sequence set in advance as a process at the time of starting the reproducing process, and is a process of executing the program (BD-J) recorded in [BDJO], [JAR] set in the BDMV directory.

For example, it is programmed so that the BD-J title expressed by [00100.bdjo] recorded in the BDJO directory in the BDMV directory 201 shown in FIG. 8 is executed at first. The BD-J title may be selected automatically at the time of insertion of the disc under the title of First Play Back set as an initial execution title. The BD-J object [00100.bdjo] recorded in the BDJO directory shown in FIG. 8 calls 01010.jar, which is the Java (registered trademark) program in the JAR directory shown in FIG. 8, issues various processing commands to the reproducing apparatus, and causes the same to perform the following processes.

In Step S103, whether the reproducing apparatus is an apparatus of the related art which executes only the BDMV application of the related art, or an expanded apparatus which is capable of reproducing the expanded data created by constructing the virtual file system (VFS) is determined. This determining process may include a process of determining the apparatus or the apparatus-packaged program using the program (BD-J) or may be performed using information entered by the user.

If the reproducing apparatus is the apparatus of the related art which executes only the BDMV application of the related art, the procedure goes to Step S104, where the reproducing process intended to reproduce only the data in the BDMV directory recorded in the media is executed.

In contrast, if the reproducing apparatus is the expanded apparatus which is capable of reproducing the expanded data produced by constructing the virtual file system (VFS), the procedure goes to Step S105.

In Step S105, a process command for copying the AV stream data in the BDAV directory to the local memory by the execution of the BD-J program is issued to the reproducing apparatus which executes the reproducing process. For reference sake, in a data processing unit of the reproducing apparatus, the BD-J, which is a program read out from the disc and the reproducing application are performed in parallel.

In this Java (registered trademark) program, a command for causing a specific file on the BD disc to be copied to the BUDA in the local memory using a class or the like of the java.io package is issued. This copy command is performed for constructing the virtual file system using the copy data for the local memory as described above. The position in the copy destination is specified by a relative pass in the BUDA in the method of Java (registered trademark). The BUDA is a virtual binding unit data area (BUDA) in the local memory which is assumed to be a data destination as described above with reference to FIG. 11. Although the root position of the BUDA (Binding Unit Data Area) is different from system to system, it is none of the BD-J application's business.

Subsequently, in Step S106, the reproducing apparatus acquires the positional information (pass) of the file specified to be copied, and notifies a copy complete notification to the BD-J. The reproducing apparatus actually does not perform the data copying process with respect to the local memory. With this process, the positional information that the reproducing apparatus acquires from the BD-J corresponds to the data 302 described above with reference to FIG. 10(b).

In other words, it is information corresponding to the stream file 205 in the BDAV directory 202 of the directory configuration (disc package) of the medium shown in FIG. 8, and correspondence information on the file names;

(b1) File Name in Copy Source (pass information on the media)

(b2) File Name of Copy Destination (pass information on the assumption that the copy destination is the local memory) shown in FIG. 10(b) are acquired.

Subsequently, in Step S107, a process command for copying the management information file (including the manifest file) in the BU directory to the local memory is issued to the reproducing apparatus by the execution of the BD-J program.

Subsequently, in Step S108, the reproducing apparatus acquires the positional information (pass) on the file specified to be copied, and notifies the copy complete notification to the BD-J. The reproducing apparatus actually does not perform the data copying process with respect to the local memory. With this process, the positional information that the reproducing apparatus acquires from the BD-J corresponds to the data 301 described above with reference to FIG. 10(b).

In other words, it is information corresponding to the data 206 from the BU directory 203 of the directory configuration (disc package) of the medium shown in FIG. 8, and correspondence information of the file names;

(b1) File Name in Copy Source (pass information on the media)

(b2) File Name of Copy Destination (pass information on the assumption that the copy destination is the local memory)

shown in FIG. 10(b) are acquired.

Subsequently, in Step S109, the BD-J program is executed to output a virtual file system (VFS) construction request to the reproducing apparatus.

Subsequently, in Step S110, the reproducing process program of the reproducing apparatus (player) the reproducing process program of the reproducing apparatus (player) creates the file name conversion table used in the virtual file system by using the positional information of the file specified to be copied, and notifies completion of VFS construction to the BD-J.

In this step S110, the file name conversion table created by the reproducing apparatus is the file name conversion table described above with reference to FIG. 10(c). In other words, it is “(c) File Name Conversion Table created in Internal Memory of Reproducing Apparatus” shown in FIG. 10(c), and is data having the following file name in one-to-one correspondence.

(c1) File Names requested to be read (File Names on Virtual Package of VFS)

(c2) Actual File Names (indicating the pass on the medium (recorded position)).

The file names in (c1) correspond to (a2) the destination file names (dst_file_name) in the BUMF in FIG. 10(a).

The file names in (c2) correspond to (b1) the file names of the copy source (pass information on the media) of a table shown in FIG. 10(b).

The information processing apparatus acquires the file name conversion table (BUMF) shown in FIG. 10(a) from data recorded in the BU directory 203 of the directory in the medium described with reference to FIG. 8. The table shown in FIG. 10(b) is acquired from the BD-J in the process of steps S105 to S108.

The correspondence relationship between (a2) and (b2) is analyzed from the relationship (a1)=(b2) in the file names shown in FIG. 10(a), FIG. 10(b), creates the file name conversion table shown in FIG. 10(c), and records the same in the memory. After this process, in Step S110, completion of construction of the virtual file system (VFS) is notified to the BD-J.

Subsequently, in Step S111, the reproducing process is executed by using the BDMV directory in the virtual package set in the virtual file system (VFS). For reference sake, at the time of data access using the virtual file system (VFS), (c2) the actual file name (indicating the pass on the medium (recorded position)) is acquired from the file names in (c1) shown in FIG. 10(c), that is, from the file name on the virtual package of (VFS), and data is acquired from the medium by using (c2) the actual file name.

In this reproducing process, a reproducing process using the index file [index.bdmv], and the movie object file [MovieObject.bdmv] set in the virtual BDMV directory 210 described above with reference to FIG. 9 is performed.

The index file [index.bdmv], and the movie object file [MovieObject.bdmv] are accessed on the basis of the file name conversion table in FIG. 10(c). That is, the index file [index.bdmv], and the movie object file [MovieObject.bdmv] as the management information set in the BU directory 203, which is an actual directory shown in FIG. 8.

In other words, at the time of reproducing process using the virtual file system (VFS), the reproducing process using the index file [index.bdmv], and the movie object file [MovieObject.bdmv] as the management information set in the BU directory 203 is performed. In the management information, the management information on all the data recorded in the BDMV directory 201 shown in FIG. 8 and the BDAV directory 202 are registered. When performing the reproducing process, a reproducing process using this management information as index information with respect to the data-to-be-reproduced is performed.

For example, the menu display is achieved by one program in the movie object file [MovieObject.bdmv] specified from the index file [index.bdmv] used in this virtual file system. In the menu, information for accessing all the data recorded in the BDMV directory and the BDAV directory is registered. Therefore, all of the BDMV standard data, and the expanded data (BDMV standard non-compliant data) can be reproduced using one menu.

As described above with reference to FIG. 9, the virtual file system includes the BDJO, JAR directories set in the virtual BDMV directory 210. Therefore, the Java (registered trademark) program stored in the BDJO, JAR directories can be used. By using the Java (registered trademark) program, the menu display having various designs is achieved. Also by using the Java (registered trademark) program, for example, the various control buttons can be displayed for achieving the reproducing process using the interactive function.

[4. Example of Processing in which Bdav Directory is not Set (Example 2)]

Subsequently, an example in which data recording and reproduction are performed without setting the BDAV directory in a recording medium will be described as Example 2.

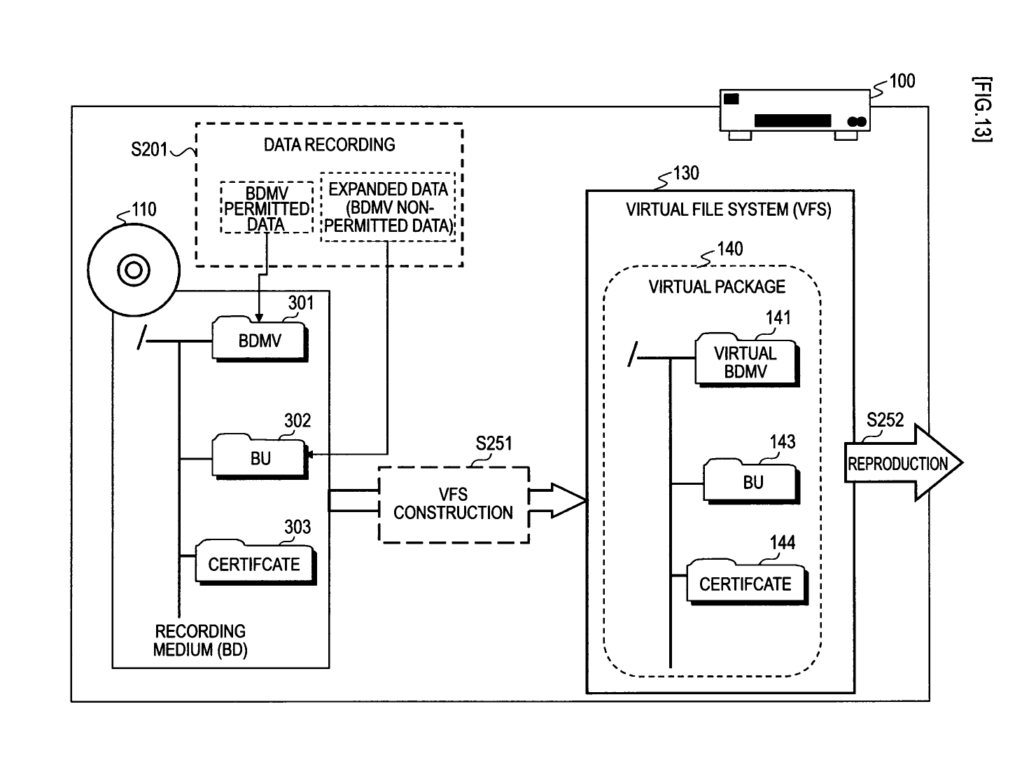

Referring now to FIG. 13, an outline of the data recording and reproducing process by the information processing apparatus according to Example 2. The information processing apparatus 100 shown in FIG. 13, having the medium (information recording medium) 110 loaded thereon, executes data recording and reproducing process. In this example as well, the medium 110 is, for example, a data recordable BD (Blu-ray Disc (registered trademark)). For reference sake, the medium 110 is not limited to the BD, but may be other media such as a flash memory.

The information processing apparatus 100 further includes the local memory 120 made up of a hard disk or the like, for example.

First of all, a data recording process for the medium 110 by the information processing apparatus 100 will be described. The medium 110 is assumed to be a data recordable medium such as a BD-RE or a BD-R. When performing only the reproducing process described later, a medium which is not rewritable, for example, the BD-ROM, may be used.

The information processing apparatus 100 sets the directories;

a BDMV directory 301,

a BU directory 302, and

a certificate (CERTIFICATE) 303 in the medium 110 as shown in FIG. 13. This process is executed by a program held by the information processing apparatus in the memory in the apparatus.

Unlike Example 1 described above with reference to FIG. 6, the BDAV directory is not used in Example 2.

The BDMV directory 301 is a directory having a similar configuration to that described above with reference to FIG. 1.

The BU directory 302 is a binding unit directory, and is a directory for recording management information and the like required when constructing the virtual file system (VFS) described later.

In Example 2, the AV stream file which is an expanded data (BDMV standard non-compliant data) is also recorded in the BU directory 302. All of the clip information files and the playlist files corresponding to these AV stream files are also recorded.

In the certificate (CERTIFICATE) directory 303, information to be applied to the construction of the virtual file system (VFS) and creation of the file name conversion table are stored.

A process to be performed when the information processing apparatus 100 executes data recording on the medium 110 is shown in Step S201.

As shown in Step S201, when the data-to-be-recorded is a BDMV standard compliant data, the recording process is performed in the BDMV directory 301. When recording the recording data having formats other than the BDMV standard, for example, the expanded data (BDMV standard non-compliant data) such as 1080/60p images, 3D images, and 4K×2K images as described above, a process of recording in the BUV directory 302 is executed.

At the time of data recording process described above, creation or renewal and recording process are performed not only on the AV stream file, but also on the clip information file and the playlist file. In addition, a renewal process on the database files such as the movie object file and the index file on an as-needed basis.

When the data recording process is executed, the management information on the BU directory 302 is renewed.

This process includes a management information renewal process required when constructing the virtual file system (VFS) described later.

In this manner, in Example 2, the information processing apparatus 100 executes the process of recording basically in the BDMV directory 301 for the BDMV standard compliant data, and executes the process of recording in the BU directory 302 for the expanded data (BDMV standard non-compliant data).

Subsequently, the outline of the data reproducing process will be described. The information processing apparatus 100 of Example 2 is capable of specifying both of the data recorded in the BDMV directory and the data set in the BU directory 302 from one menu for the reproducing process. This menu is a menu creatable according to the BDMV standard.

Both of the data recorded in the BDMV directory 301 and the data set in the BU directory 302 can be reproduced using the interactive function which is available in the BDMV standard.

At the time of reproducing process, first of all, as shown in Step S251 shown in FIG. 13, a process of constructing the virtual file system (VFS) 130 on the basis of the data recorded in the medium 110 is performed. Subsequently, in Step S252, the reproducing process using the virtual file system (VFS) 130 is executed.

The virtual file system (VFS) 130 is a virtual file system used by a reproduction application program executed by the information processing apparatus 100, and includes a virtual package 140 having a directory configuration shown in the drawing. The information processing apparatus 100 constructs a virtual package 140 having a directory configuration shown in the drawing in a memory of the information processing apparatus, and performs data access.

The virtual file system (VFS) 130 is not used for accessing the stored data in the local memory, but is constructed for accessing all the data stored in the medium 110.

The directories are in the virtual file system, as shown in the drawing,

the virtual BDMV directory 141,

the BU directory 143, and

the CERTIFICATE directory 144.

In the virtual BDMV directory 141 in the virtual file system (VFS) 130, in addition to files set in the BDMV directory 301 in the medium 110, files set in the BU directory 303 are set as virtual files.

The reproducing application of the information processing apparatus which performs a reproducing process applied with the virtual file system accesses the virtual BDMV directory 141 and acquires an AV stream file as the data to be reproduced.

Since the BDMV directory 111, which is the actual directory in the medium 110 and the AV stream file set in the BDAV directory 112 are set in the virtual BDMV directory 141, the application is capable of accessing and reproducing all the data-to-be-reproduced stored in the medium 110 without performing accessing the BDAV directory 142 in the virtual file system (VFS) 130. The detailed reproduction sequence is substantially the same process as the process following the flow in FIG. 12 described above in Example 1. However, the process in Step S105 in the flow in FIG. 12 is changed to the process not for the BDAV directory, but for the BU directory.

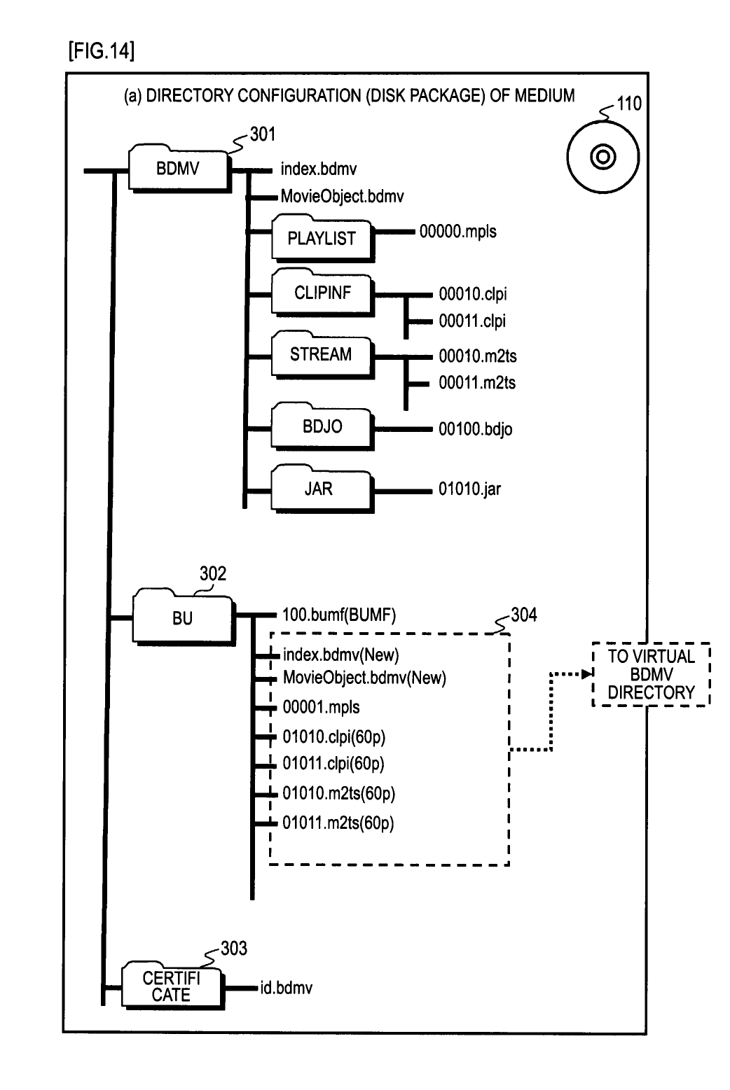

The detailed example of the directory configuration in the medium 110 in this example is shown in FIG. 14.

(a) The directory configuration (disc package) of the medium shown in FIG. 14 includes; the BDMV directory 301, and

the BU directory 302,

a certificate (CERTIFICATE) directory 303.

In the BDMV directory 301, data compliant with the BDMV standard and the management information on the data is recorded.

In the BU directory 302, the management information file used when constructing the virtual file system (VFS) and the file name conversion table (manifest file (BUMF)) described above are recorded.

In the certificate (CERTIFICATE) directory 303, information to be applied to the construction of the virtual file system (VFS) and the creation of the file name conversion table are stored.

As shown in FIG. 14, the stream file recorded in the BU directory 302 and the data 304 including the management information are set in the virtual BDMV directory in the virtual file system (VFS).

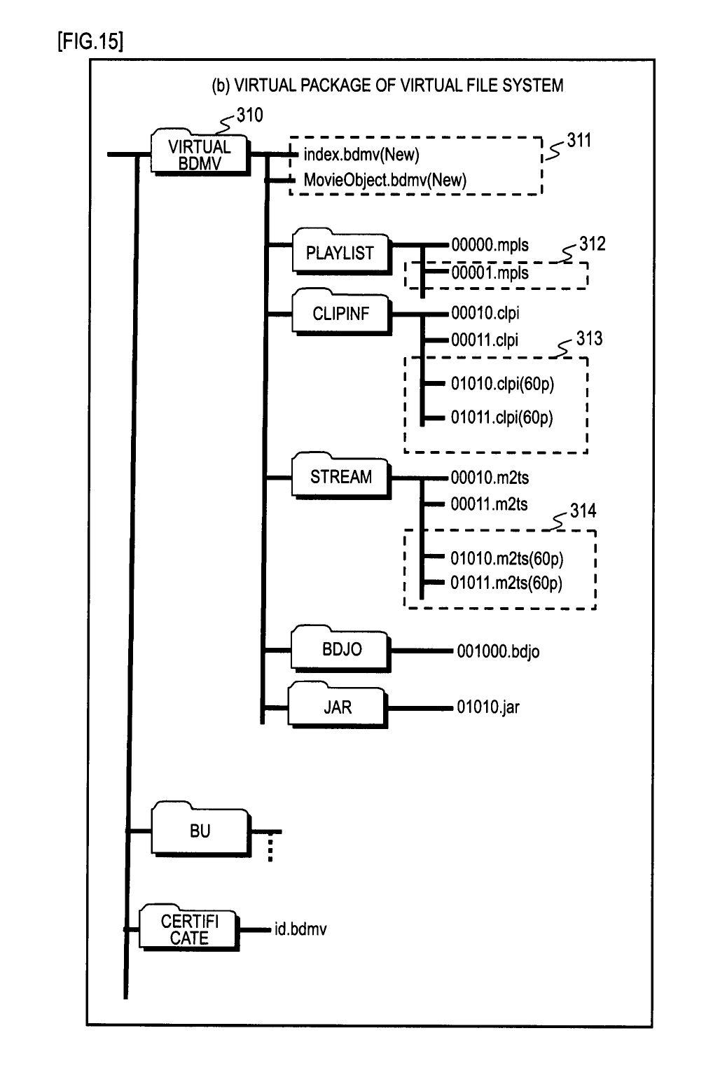

Referring now to FIG. 15, a configuration of the virtual file system (VFS) will be described.

The files shown in FIG. 15 as management information file 311;

an index file [index.bdmv (New)], and

a movie object file [MovieObject.bdmv (New)]

are originally data 304 recorded in the BU directory 302 in the medium 110 shown in FIG. 14.

Although the index file [index.bdmv], and the movie object file [MovieObject.bdmv] are set also in the BDMV directory in (a) the directory configuration (disc package) of the medium, when using the virtual file system, the index file [index.bdmv], and the movie object file [MovieObject.bdmv] in the data 304 recorded in the BU directory 302 are used.

The index file [index.bdmv], and the movie object file [MovieObject.bdmv] set in the BDMV directory in (a) the directory configuration (disc package) of the medium include only management information set in the BDMV directory of the medium.

However, the index file [index.bdmv], and the movie object file [MovieObject.bdmv] of the data 304 recorded in the BU directory 302 shown in FIG. 14 are set as data including not only the data recorded in the BDMV directory 301 of the media, but also the management information on the expanded data recorded in the BU directory 302.

In the reproducing process using the virtual file system, the reproducing process is performed not only on the data recorded in the BDMV directory 301 of the medium, but also on the expanded data recorded in the BU directory 302, the index file [index.bdmv], and the movie object file [MovieObject.bdmv] in the data 304 recorded in the BU directory 302 are set as the management information file 311 in the virtual BDMV directory 310 shown in FIG. 14.

In addition, the following files shown in (b) the virtual package of the virtual file system (VFS) shown in FIG. 15, that is;

a playlist file [00001.mpls] 312

a clip information file [01010.clpi] (60p) 313,

a clip information file [01011.clpi] (60p) 313,

an AV stream file [01010.m2ts] (60p) 314, and

an AV stream file [01011.m2ts] (60p) 314,

correspond to the data 304 recorded in the BU directory 302 of the disc package shown in FIG. 14.

The files 211 to 214 shown in (b) the virtual package of the virtual file system (VFS) shown in FIG. 15 is acquired from the medium 110 by using the file name conversion table described above with reference to FIG. 10(c).

In this example, the process can be performed without setting the BDAV directory in the medium. In the data reproducing process, the reproducing process using the index file [index.bdmv], and the movie object file [MovieObject.bdmv] as the management information set in the BU directory in the same manner as Example 1 described above is performed. In these management information, the management information on all the data recorded in the BDMV directory and the BU directory are registered. When performing the reproducing process, a reproducing process using this management information as index information with respect to the data-to-be-reproduced is performed.

For example, the menu display is achieved by one program in the movie object file [MovieObject.bdmv] specified from the index file [index.bdmv]. In the menu, information for accessing all the data recorded in the BDMV directory and the BU directory is registered. Therefore, all of the BDMV standard data, and the expanded data (BDMV standard non-compliant data) can be reproduced using one menu.

For reference sake, as shown in FIG. 15, BDJO, JAR directories set in the BDMV directory are included in the virtual file system. Therefore, the Java (registered trademark) program stored in the BDJO, JAR directories can be used. By using the Java (registered trademark) program, the menu display having various designs is achieved. Also by using the Java (registered trademark) program, for example, the various control buttons can be displayed for achieving the reproducing process using the interactive function.

### [5. Example of Configuration of Information Processing Apparatus]

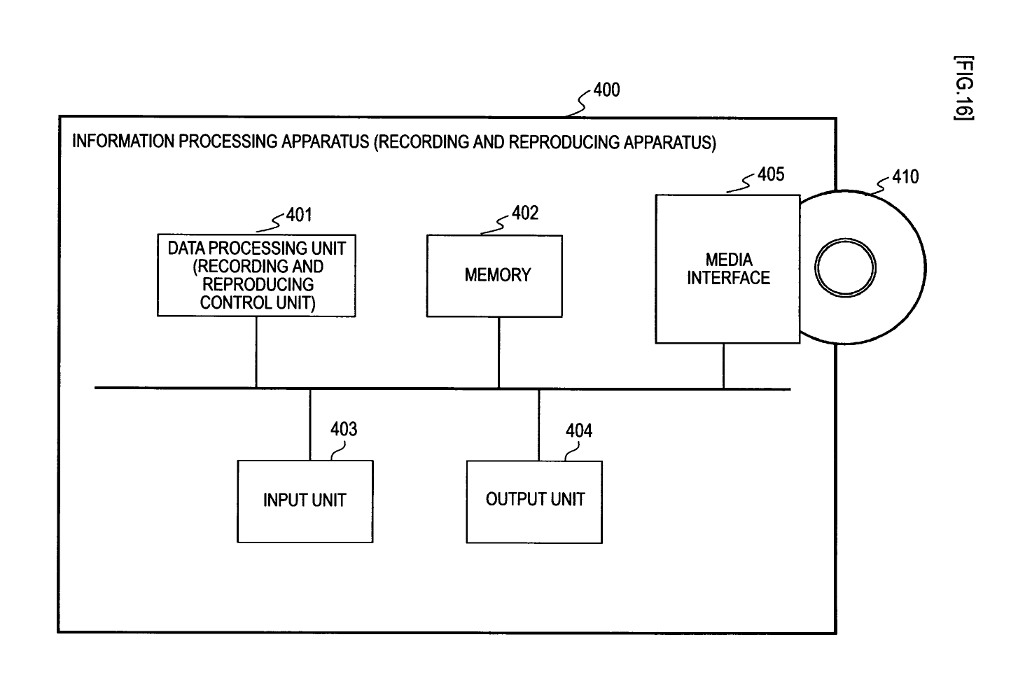

Referring now to FIG. 16, an example of configuration of the information processing apparatus that executes the recording and reproducing process described above will be described. FIG. 16 is a block diagram showing an example of configuration of an information processing apparatus 400 according to an example of the present invention. The information processing apparatus 400 is an apparatus configured to perform at least either one of processes of data recording or data reproduction with respect to a medium 410. More specifically, for example, the information processing apparatus 400 is an apparatus such as a recording and reproducing apparatus, a player apparatus, a recorder apparatus, a video camera, and a PC.

Although a disc-type medium is shown as the medium 410 in FIG. 16, the medium is not limited to the disc-type medium and may be a medium such as a flash memory.

As shown in FIG. 16, the information processing apparatus 400 includes a data processing unit (recording and reproducing control unit) 401, a memory 402, an input unit 403, an output unit 404, and a media interface 405.

The data processing unit 401 includes a CPU having a program executing function for executing various data processing programs. For example, an application program for performing a data recording and reproducing process is executed. For example, the process following the flowchart described with reference to FIG. 12 is executed.

The memory 402 is made up of a RAM, a ROM, or the like, and is used as a storage area for storing the application programs executed by the data processing unit 401. The memory 402 is used as parameters for application, or a work area and, in addition, is also used as a buffer area for media recording data.

The input unit 403 is, for example, an operation unit for users, and allows various inputs such as an input of data recording or reproducing command. The input unit 403 also includes a remote controller, and allows an input of remote controller operation information. The output unit 404 is an output unit for images or voices, which is made up of a display, a speaker, or the like.

The media interface 405 is an interface applied to the data recording and reproducing process using the medium 410. The data is written in the medium 410 according to a request from the data processing unit 401, and a data reading process from the medium 410 or the like is performed.

The present invention has been described in detail with reference to specific examples. However, it is apparent that those skilled in the art can correct or replace the examples without departing the scope of the present invention. In other word, the present invention has been disclosed in the form of exemplification, and should not be interpreted restrictively. In order to determine the scope of the present invention, appended claims are to be made allowance for.

A series of processes described in the specification may be executed by hardware, software, or a composite configuration including the both. Execution of the process by software is achieved by installing the program having the process sequence recorded therein in a memory of a computer, which is built in a specific hardware, and causing the computer to execute the process or, alternatively, by installing the program in a general computer which is capable of executing various processes and causing the computer to execute the process. For example, the program may be recorded in the recording media in advance. In addition to installing from the recording medium to the computer, it is also possible to receive the program via a network such as LAN (Local Area Network) or internet and installing the same in a recording medium such as an integrated hard disk.

The various processes described in the specification may be executed not only in time sequence according to the description, but also in parallel or individually according to a processing capability of the apparatus which executes the process. In this specification, the term “system” means a configuration of a logical set of a plurality of apparatuses, and is not limited to those having a plurality of apparatuses of various configurations in an identical housing.

### INDUSTRIAL APPLICABILITY

As described thus far, according to an example of the present invention, at the time of data reproducing process from a medium having a plurality of directories including BDMV standard compliant data in the BDMV directory, and BDMV standard non-compliant data, for example, 1080/60p or 3D image data, in the BDAV or BU directory, the reproducing process is performed by constructing the virtual file system in which the virtual file name for the recorded data in the BDAV or BU directory is set without performing the data transfer to the local memory. With this configuration, the recording and reproducing of the BDMV standard compliant data and the BDMV standard non-compliant data can be performed without performing the data transfer to the local memory.

### REFERENCE SIGNS LIST

10 medium
20 local memory
30 virtual file system (VFS)
40 virtual package
41 virtual directory
50 application program
70 file name conversion table (BUMF)
100 information processing apparatus
110 medium (information recording medium)
111 BDMV directory
112 BDAV directory
113 BU directory
114 CERTIFICATE directory
130 virtual file system (VFS)
140 virtual package
141 virtual BDMV directory
142 BDAV directory
143 BU directory
144 CERTIFICATE directory
201 BDMV directory
202 BDAV directory
203 BU directory
204 CERTIFICATE directory
210 virtual BDMV directory
250 BUDA directory
251 Organization directory
252 disc directory
260 data
301 BDMV directory
302 BU directory
303 CERTIFICATE directory
400 information processing apparatus
401 data processing unit
402 memory
403 input unit
404 output unit
405 media interface
410 medium

1. An information processing apparatus comprising: a data processing unit configured to perform a data reproducing process from a recording medium, wherein
the data processing unit has a configuration of constructing a virtual file system in which a virtual file name is set for part of data recorded in the recording medium, and
executing the data reproducing process in which the constructed virtual file system is applied, and
the data processing unit
creates a first file name conversion table including the virtual file name set in the virtual file system and a file name indicating a data recording destination in the recording medium in one-to-one correspondence for the data for which the virtual file name is set,
thereby constructing the virtual file system without performing data transfer in the recording medium.

2. The information processing apparatus according to claim 1, wherein the data processing unit has a configuration of
constructing the virtual file system including data set in a first directory for recording data compliant with a first application standard set in the recording medium and data set in a directory other than the first directory set in one virtual directory and
executing the data reproducing process in which the constructed virtual file system is applied, and
the data processing unit
creates the first file name conversion table including a file name set in the virtual file system and the file name indicating the data recording destination in the recording medium in one-to-one correspondence for the data set in directories other than the first directory, and
constructs the virtual file system without transferring data set in the directory other than the first directory.

3. The information processing apparatus according to claim 2, wherein the data processing unit
acquires a file name of data-to-be-copied included in a data copy command, which is a process command for storing the data set in the directory other than the first directory in a local memory and creating the first file name conversion table.

4. The information processing apparatus according to claim 3, wherein the data copy command is a data copy command issued by executing a program recorded in the recording medium.

5. The information processing apparatus according to claim 2, wherein the data processing unit
creates a second file name conversion table created on the assumption of being used in the virtual file system constructed by storing data set in the directory other than the first directory in the local memory and
the first file name conversion table by using the file name of the data-to-be-copied included in the data copy command.

6. The information processing apparatus according to claim 2, wherein the data processing unit
sets management information on all data-to-be-reproduced set in the first directory and the directory other than the first directory in the virtual directory set in the virtual file system as the management information used as index information on the data-to-be-reproduced and performs the data reproducing process using the management information.

7. The information processing apparatus according to claim 6, wherein the data processing unit
the management information is management information including any one of an index file, a movie object file, a playlist file, or a clip information file to be applied to the reproducing process on the basis of the virtual file system.

8. The information processing apparatus according to claim 2, wherein
the first application standard is a BDMV standard, and the first directory is a BDMV directory, and
the data processing unit constructs the virtual file system having a virtual BDMV directory which is set to record:
the first directory includes
the data-to-be-reproduced recorded in the BDMV directory,
the data-to-be-reproduced recorded in a BDAV directory which is different from the BDMV directory, and
the management information recorded in a third directory other than the BDMV and BDAV directories as data-to-be-recorded.

9. The information processing apparatus according to claim 2, wherein the first application standard is the BDMV standard and the first directory is the BDMV directory, and
the data processing unit constructs the virtual file system having the virtual BDMV directory which is set to record:
the first directory includes
the data-to-be-reproduced recorded in the BDMV directory,
data-to-be-reproduced and the management information recorded in a second directory different from the BDMV directory as the data-to-be-recorded.

10. An information processing method for executing data reproduction from a recording medium in an information processing apparatus comprising:
a virtual file system constructing step for constructing a virtual file system in which a virtual file name is set for part of data recorded in the recording medium by a data processing unit; and
a data reproducing step for executing a data reproducing process in which the virtual file system is applied by the data processing unit, wherein
the virtual file system constructing step is a step of creating a first file name conversion table including the virtual file name set in the virtual file system and a file name indicating a data recording destination in the recording medium in one-to-one correspondence for data having the virtual file name set thereto, and
constructing the virtual file system without performing data transfer in the recording medium.

11. A program that causes an information processing apparatus to execute data reproduction from a recording medium comprising:
a virtual file system constructing step for causing a data processing unit to construct a virtual file system in which a virtual file name is set for part of data recorded in the recording medium; and
a data reproducing step for causing the data processing unit to execute a data reproducing process in which the virtual file system is applied,
wherein the virtual file system constructing step is a step of causing to create a first file name conversion table including the virtual file name set in the virtual file system and a file name indicating a data recording destination in the recording medium in one-to-one correspondence for data having the virtual file name set thereto, and
causing to construct the virtual file system without performing data transfer in the recording medium.
